(19) United States
(12) Patent Application Publication
(10) Pub. No.: US 2025/0240445 A1
(43) Pub. Date: Jul. 24, 2025

(54) VIDEO CODING AND DECODING

(71) Applicant: CANON KABUSHIKI KAISHA, Tokyo (JP)

(72) Inventors: Guillaume LAROCHE, Saint Aubin d'Aubigné (FR); Patrice ONNO, Rennes (FR); Romain BELLESSORT, St Grégoire (FR)

(21) Appl. No.: 18/855,522

(22) PCT Filed: Apr. 11, 2023
(86) PCT No.: PCT/EP2023/059429

§ 371 Date: Oct. 9, 2024

(30) Foreign Application Priority Data
Apr. 11, 2022 (GB) 2205318.5

(51) Int. Cl. H04N 19/513

(52) U.S. Cl. CPC H04N 19/513

(57) ABSTRACT

Improvements to the derivation and ordering of motion vector predictor candidates for predicting motion in an image portion are disclosed. A list of motion vector predictor candidates for predicting motion in an image portion is generated, in which a first set of motion vector predictor candidates to said list and a second set of motion vector predictor candidates is added to said list if the number of first set of motion vector predictor candidates is lower than a maximum candidate number so that the total number of candidates equals said maximum candidate number The list of candidates is reordered and said second set of candidates are excluded from said reordering.

### FIELD OF INVENTION

The present invention relates to video coding and decoding.

### BACKGROUND

The Joint Video Experts Team (JVET), a collaborative team formed by MPEG and ITU-T Study Group 16's VCEG, released a new video coding standard referred to as Versatile Video Coding (VVC). The goal of VVC is to provide significant improvements in compression performance over the existing HEVC standard (i.e., typically twice as much as before). The main target applications and services include—but not limited to—360-degree and high-dynamic-range (HDR) videos. Particular effectiveness was shown on ultra-high definition (UHD) video test material. Thus, we may expect compression efficiency gains well-beyond the targeted 50% for the final standard.

Since the end of the standardisation of VVC v1, JVET has launched an exploration phase by establishing an exploration software (ECM). It gathers additional tools and improvements of existing tools on top of the VVC standard to target better coding efficiency.

Amongst other modifications, compared to HEVC, VVC has a modified set of ‘merge modes’ for motion vector prediction which achieves greater coding efficiency at a cost of greater complexity. Motion vector prediction is enabled by deriving a list of ‘motion vector predictor candidates’ with the index of the selected candidate being signalled in the bitstream. The merge candidate list is generated for each coding unit (CU). But CUs may be split into smaller blocks for Decoder-side Motion Vector Refinement (DMVR) or other methods.

The make-up and order of this list can have significant impact on coding efficiency as an accurate motion vector predictor reduces the size of the residual or the distortion of the block predictor, and having such a candidate at the top of the list reduces the number of bits required to signal the selected candidate. The present invention aims to improve at least one of these aspects.

Modifications incorporated into VVC v1 and ECM mean there can be up to 10 motion vector predictor candidates; this enables a diversity of candidates, but the bitrate can increase if candidates lower down the list are selected. The present invention broadly relates to improvements to the ordering of the candidates in the list of motion vector predictor candidates. In particular, instances where a computed cost of a candidate is not representative of how likely that candidate is to be selected. Reordering the list can lead to coding efficiency gains, and efficient methods of reordering can lead to a complexity reduction. The various embodiments of the invention achieve one or both of these advantages.

According to one aspect of the invention there is provided a method of generating a list of motion vector predictor candidates for predicting motion in an image portion, the method comprising: adding a first set of motion vector predictor candidates to said list; adding a second set of motion vector predictor candidates to said list if the number of first set of motion vector predictor candidates is lower than a maximum candidate number so that the total number of candidates equals said maximum candidate number; reordering said list of candidates; wherein said second set of candidates are excluded from said reordering. Optionally, the first set does not include duplicates.

In a further aspect of the invention, there is provided a method of generating a list of motion vector predictor candidates for predicting motion in an image portion, the method comprising: adding a first set of motion vector predictor candidates to said list; determining duplicate candidates in said list; adding a second set of motion vector predictor candidates to said list if the number of first set of motion vector predictor candidates is lower than a maximum candidate number so that the total number of candidates equals said maximum candidate number; and reordering said list of candidates, wherein said duplicate candidates are excluded from said reordering. Optionally, said second set of candidates are also excluded from said reordering.

The following statements are applicable to either of the above mentioned aspects:

Optionally, said second set of motion vector predictors are zero candidates and said first set of candidates are not zero candidates.

The first set of candidates may be candidates derived from at least one previously decoded or encoded motion information. Optionally, said first set of candidates are candidates derived from true samples comprise one or more of temporal candidates, spatial candidates, historical candidates, previously used candidates, or candidates derived from other candidates

The reordering may be based on a computed relative cost of said candidates. Optionally, at least one candidate is derived from at least one spatially or temporally matched template; wherein templates inside a delimited area are available and templates outside of the delimited area are non-available; and if at least one template is non-available, computing a non-zero cost for said candidate.

In a yet further aspect of the invention, there is provided a method of generating a list of motion vector predictor candidates for predicting motion in an image portion, the method comprising: adding a plurality of motion vector predictor candidates to a list; computing a cost associated with at least one candidate in said list; wherein said at least one candidate is derived from at least one spatially or temporally matched template; wherein templates inside a delimited area relative to said image portion are available and templates outside of the delimited area are non-available; if at least one template is non-available; computing a non-zero cost for said candidate; reordering said list in dependence on said computed cost.

The cost may be determined based on the sizes of the one or more templates from which the candidate is derived.

The cost may be determined based on the number of samples of an available template and on the non-available template. For example, the cost may be determined based on a ratio of available and non-available samples.

Optionally, a division used in determining said cost is approximated to a shift operation.

Optionally, the cost value for the non-available template is set equal to the cost value of the related available template.

Optionally, if no templates are available, the cost is set to a maximum value. For example, a candidate where no related template is available may be reordered in the list immediately above the motion vector predictor candidates added if the number of added motion vector predictor candidates is lower than a maximum candidate number so that the total number of candidates equals said maximum candidate number. Optionally, said maximum value is lower than a cost assigned to motion vector predictor candidates added if the number of added motion vector predictor candidates is lower than a maximum candidate number so that the total number of candidates equals said maximum candidate number.

In an embodiment the cost for said candidate is assigned a maximum value.

Optionally, at least one candidate is a bi-directional candidate with two spatially matched templates, and the cost of the available template is used to replace the cost of the unavailable template when determining the cost of said bi-directional candidate.

Optionally, said at least one candidate is a bi-directional candidate with two spatially matched templates, and the cost of said bi-directional candidate is computed only using the available template.

If one template is partially available the cost may be computed for the samples available or the cost for the non-available template corresponds to the cost of the related available template.

The method may further comprise applying a weight to the computed cost of a candidate where a template is not available

In a yet further aspect of the invention, there is provided a method of generating a list of motion vector predictor candidates for predicting motion in an image portion, the method comprising: adding a plurality of motion vector predictor candidates to a list; wherein at least one candidate in the list is derived from at least one spatially or temporally matched template; wherein templates inside a delimited area relative to said image portion are available and templates outside of the delimited area are non-available; and reordering the list unless at least one template is non-available.

Optionally, the reordering is performed unless all of the templates are non-available.

In another aspect of the invention there is provided a method of generating a list of motion vector predictor candidates for predicting motion in an image portion, the method comprising:
determining the availability of at least one template related to a template of the image portion; and deriving the motion vector predictor candidates according to this template availability.

Optionally, if at least one template is non-available, the method comprises adding a further at least one temporal candidate to the list.

Optionally, the number of temporal candidates is the same whatever the availability of the template.

Optionally, the method further comprises decreasing a maximum candidate number.

Optionally, the method further comprises reducing a motion vector threshold prior to adding said further temporal candidate.

The cost of a candidate in the list may be computed based on a comparative measure between at least one sample associated with the candidate and at least one another sample. The cost for a candidate may be computed based on the difference between a neighboring samples of predictors block and the neighboring samples of a current block. Optionally, the cost for a candidate is computed by calculating a difference of two blocks' predictors. Optionally, the cost for a candidate is computed by calculating a difference with another candidate in the list. Optionally, the other candidate is a most probable candidate. Optionally, the cost is based on sub-sampling of neighbouring or samples of the predictors. Optionally, the cost is based on samples corresponding to an image from another resolution. Optionally, a value of the samples used to compute the cost is pre-processed.

Optionally, the cost corresponds to a distortion. Said distortion may be a SAD, SATD, SSE or SSIM.

Optionally, the cost comprises a weight. Said weight may differ between motion vector predictor candidates. The method may further comprise deriving a variable corresponding to the number of motion vector predictor candidates in the first set and the reordering of the list is performed in dependence on the variable.

In the above aspects and embodiments, optionally, a variable identifies the first candidate from the second set of motion vector predictor candidates. Each motion vector predictor candidate in the second set may be associated with a variable, and the reordering is performed in dependence on these variables. The method optionally comprises setting the non-reordered motion vector predictor candidates to the end of the list.

The method may include performing a second reordering process on the non-reordered motion vector predictor candidates.

The method may include performing a second reordering process on the non-reordered motion vector predictor candidates when the first set contains no more than one candidate.

The method may include performing a second reordering process on the non-reordered motion vector predictor candidates in dependence on the coding mode.

Said second reordering is, optionally, not applied for subblock merge mode.

Optionally, the method further comprises performing a second reordering process on the non-reordered motion vector predictor candidates when the mode has a number of candidates above a threshold.

In another aspect of the invention there is provided a method of encoding image data into a bitstream comprising generating a list of motion vector predictor candidates according to any of the aspects and embodiments described above.

In another aspect of the invention there is provided a method of decoding image data from a bitstream comprising generating a list of motion vector predictor candidates according to any of the aspects and embodiments described above.

In another aspect of the invention there is provided a device for encoding image data into a bitstream, the device being configured to perform a method of generating a list of motion vector predictor candidates according to any of the aspects and embodiments described above

In another aspect of the invention there is provided a device for decoding image data from a bitstream, the device being configured to perform a method of generating a list of motion vector predictor candidates according to any of the aspects and embodiments described above

In another aspect of the invention there is provided a computer program which upon execution causes the method of any of to any of the aspects and embodiments described above to be performed. The computer program may be stored on computer-readable carrier medium that may be transitory or non-transitory.

Other aspects of the invention relate to corresponding encoding methods, an encoding device, a decoding device, and a computer program operable to carry out the decoding and/or encoding methods of the invention.

The program may be provided on its own or may be carried on, by or in a carrier medium. The carrier medium may be non-transitory, for example a storage medium, in particular a computer-readable storage medium. The carrier medium may also be transitory, for example a signal or other transmission medium. The signal may be transmitted via any suitable network, including the Internet. Further features of the invention are characterised by the independent and dependent claims

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

Further aspects of the invention are provided by the independent and dependent claims.

### BRIEF DESCRIPTION OF THE DRAWINGS

Reference will now be made, by way of example, to the accompanying drawings, in which:

FIG. 1 is a diagram for use in explaining a coding structure used in HEVC;

FIG. 2 is a block diagram schematically illustrating a data communication system in which one or more embodiments of the invention may be implemented;

FIG. 3 is a block diagram illustrating components of a processing device in which one or more embodiments of the invention may be implemented;

FIG. 4 is a flow chart illustrating steps of an encoding method according to embodiments of the invention;

FIG. 5 is a flow chart illustrating steps of a decoding method according to embodiments of the invention;

FIGS. 6 and 7 show the labelling scheme used to describe blocks situated relative to a current block;

FIGS. 8(a) and (b) illustrate the Affine (SubBlock) mode;

FIGS. 9(a), (b), (c), (d) illustrate the geometric mode;

FIG. 10 illustrates the first steps of the Merge candidates list derivation of VVC;

FIG. 11 illustrates further steps of the Merge candidates list derivation of VVC;

FIG. 12 illustrates the derivation of a pairwise candidate;

FIG. 13 illustrates the template matching method based on neighbouring samples;

FIG. 14 illustrates a modification of the first steps of the Merge candidates list derivation shown in FIG. 10;

FIG. 15 illustrates a modification of the further steps of the Merge candidates list derivation shown in FIG. 11;

FIG. 16 illustrates a modification of the derivation of a pairwise candidate shown in FIG. 12;

FIG. 17 illustrates the costs determination of a list candidates;

FIG. 18 illustrates the reordering process of the list of Merge mode candidates;

FIG. 19 illustrates the pairwise candidate derivation during the reordering process of the list of Merge mode candidates;

FIG. 20 illustrates the Merge candidates list derivation of the present invention;

FIG. 21 illustrates the reordering process of the list of Merge mode candidates of the present invention;

FIG. 22 illustrates three examples of templates for a candidate outside an area;

FIG. 23 illustrates three examples of templates for the current block outside an area;

FIG. 24 illustrates an example of one template outside an area for bi-prediction;

FIG. 25 is a diagram showing a system comprising an encoder or a decoder and a communication network according to embodiments of the present invention.

FIG. 26 is a schematic block diagram of a computing device for implementation of one or more embodiments of the invention;

FIG. 27 is a diagram illustrating a network camera system;

FIG. 28 is a diagram illustrating a smart phone;

### DETAILED DESCRIPTION

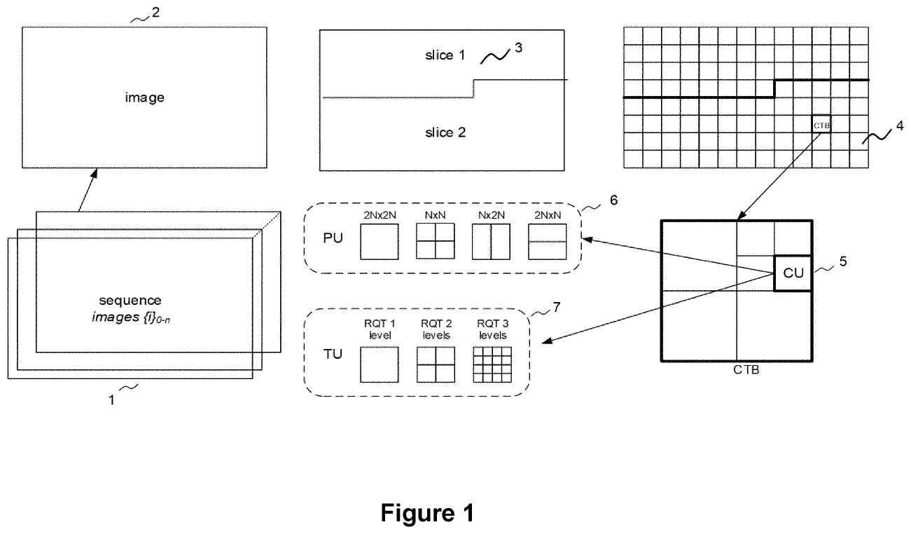

FIG. 1 relates to a coding structure used in the High Efficiency Video Coding (HEVC) video and Versatile Video Coding (VVC) standards. A video sequence 1 is made up of a succession of digital images i. Each such digital image is represented by one or more matrices. The matrix coefficients represent pixels.

An image 2 of the sequence may be divided into slices 3. A slice may in some instances constitute an entire image. These slices are divided into non-overlapping Coding Tree Units (CTUs). A Coding Tree Unit (CTU) is the basic processing unit of the High Efficiency Video Coding (HEVC) video standard and conceptually corresponds in structure to macroblock units that were used in several previous video standards. A CTU is also sometimes referred to as a Largest Coding Unit (LCU). A CTU has luma and chroma component parts, each of which component parts is called a Coding Tree Block (CTB). These different color components are not shown in FIG. 1.

A CTU is generally of size 64 pixels×64 pixels for HEVC, yet for VVC this size can be 128 pixels×128 pixels. Each CTU may in turn be iteratively divided into smaller variable-size Coding Units (CUs) 5 using a quadtree decomposition.

Coding units are the elementary coding elements and are constituted by two kinds of sub-unit called a Prediction Unit (PU) and a Transform Unit (TU). The maximum size of a PU or TU is equal to the CU size. A Prediction Unit corresponds to the partition of the CU for prediction of pixels values. Various different partitions of a CU into PUs are possible as shown by 606 including a partition into 4 square PUs and two different partitions into 2 rectangular PUs. A Transform Unit is an elementary unit that is subjected to spatial transformation using DCT. A CU can be partitioned into TUs based on a quadtree representation 607.

Each slice is embedded in one Network Abstraction Layer (NAL) unit. In addition, the coding parameters of the video sequence are stored in dedicated NAL units called parameter sets. In HEVC and H.264/AVC two kinds of parameter sets NAL units are employed: first, a Sequence Parameter Set (SPS) NAL unit that gathers all parameters that are unchanged during the whole video sequence. Typically, it handles the coding profile, the size of the video frames and other parameters. Secondly, a Picture Parameter Set (PPS) NAL unit includes parameters that may change from one image (or frame) to another of a sequence. HEVC also includes a Video Parameter Set (VPS) NAL unit which contains parameters describing the overall structure of the bitstream. The VPS is a type of parameter set defined in HEVC, and applies to all of the layers of a bitstream. A layer may contain multiple temporal sub-layers, and all version 1 bitstreams are restricted to a single layer. HEVC has certain layered extensions for scalability and multiview and these will enable multiple layers, with a backwards compatible version 1 base layer.

Other ways of splitting an image have been introduced in VVC including subpictures, which are independently coded groups of one or more slices.

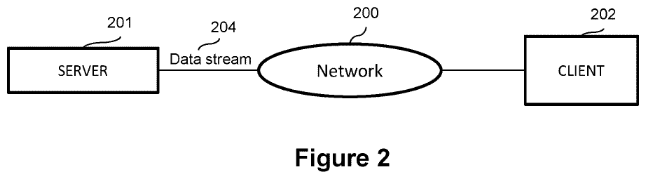

FIG. 2 illustrates a data communication system in which one or more embodiments of the invention may be implemented. The data communication system comprises a transmission device, in this case a server 201, which is operable to transmit data packets of a data stream to a receiving device, in this case a client terminal 202, via a data communication network 200. The data communication network 200 may be a Wide Area Network (WAN) or a Local Area Network (LAN). Such a network may be for example a wireless network (Wifi/802.11a or b or g), an Ethernet network, an Internet network or a mixed network composed of several different networks. In a particular embodiment of the invention the data communication system may be a digital television broadcast system in which the server 201 sends the same data content to multiple clients.

The data stream 204 provided by the server 201 may be composed of multimedia data representing video and audio data. Audio and video data streams may, in some embodiments of the invention, be captured by the server 201 using a microphone and a camera respectively. In some embodiments data streams may be stored on the server 201 or received by the server 201 from another data provider, or generated at the server 201. The server 201 is provided with an encoder for encoding video and audio streams in particular to provide a compressed bitstream for transmission that is a more compact representation of the data presented as input to the encoder.

In order to obtain a better ratio of the quality of transmitted data to quantity of transmitted data, the compression of the video data may be for example in accordance with the HEVC format or H.264/AVC format or VVC format.

The client 202 receives the transmitted bitstream and decodes the reconstructed bitstream to reproduce video images on a display device and the audio data by a loud speaker.

Although a streaming scenario is considered in the example of FIG. 2, it will be appreciated that in some embodiments of the invention the data communication between an encoder and a decoder may be performed using for example a media storage device such as an optical disc.

In one or more embodiments of the invention a video image is transmitted with data representative of compensation offsets for application to reconstructed pixels of the image to provide filtered pixels in a final image.

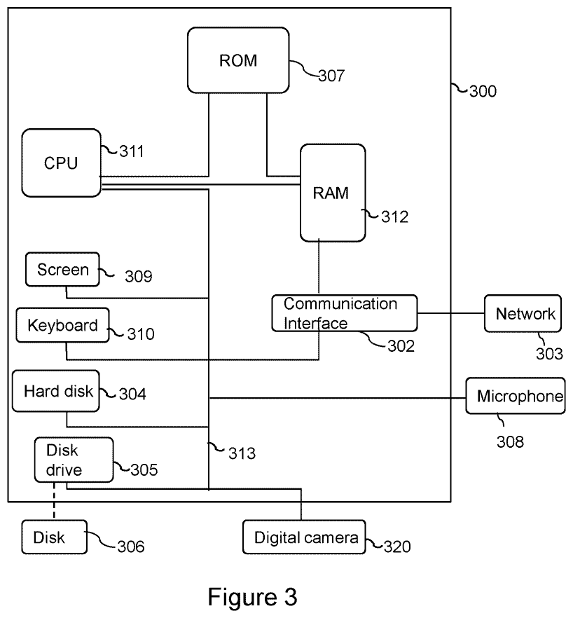

FIG. 3 schematically illustrates a processing device 300 configured to implement at least one embodiment of the present invention. The processing device 300 may be a device such as a micro-computer, a workstation or a light portable device. The device 300 comprises a communication bus 313 connected to:
a central processing unit 311, such as a microprocessor, denoted CPU;
a read only memory 306, denoted ROM, for storing computer programs for implementing the invention;
a random access memory 312, denoted RAM, for storing the executable code of the method of embodiments of the invention as well as the registers adapted to record variables and parameters necessary for implementing the method of encoding a sequence of digital images and/or the method of decoding a bitstream according to embodiments of the invention; and
a communication interface 302 connected to a communication network 303 over which digital data to be processed are transmitted or received

Optionally, the apparatus 300 may also include the following components:
a data storage means 304 such as a hard disk, for storing computer programs for implementing methods of one or more embodiments of the invention and data used or produced during the implementation of one or more embodiments of the invention;
a disk drive 305 for a disk 306, the disk drive being adapted to read data from the disk 306 or to write data onto said disk;
a screen 309 for displaying data and/or serving as a graphical interface with the user, by means of a keyboard 310 or any other pointing means.

The apparatus 300 can be connected to various peripherals, such as for example a digital camera 320 or a microphone 308, each being connected to an input/output card (not shown) so as to supply multimedia data to the apparatus 300.

The communication bus provides communication and interoperability between the various elements included in the apparatus 300 or connected to it. The representation of the bus is not limiting and in particular the central processing unit is operable to communicate instructions to any element of the apparatus 300 directly or by means of another element of the apparatus 300.

The disk 306 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in read only memory 306, on the hard disk 304 or on a removable digital medium such as for example a disk 306 as described previously. According to a variant, the executable code of the programs can be received by means of the communication network 303, via the interface 302, in order to be stored in one of the storage means of the apparatus 300 before being executed, such as the hard disk 304.

The central processing unit 311 is adapted to control and direct the execution of the instructions or portions of software code of the program or programs according to the invention, instructions that are stored in one of the aforementioned storage means. On powering up, the program or programs that are stored in a non-volatile memory, for example on the hard disk 304 or in the read only memory 306, are transferred into the random access memory 312, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

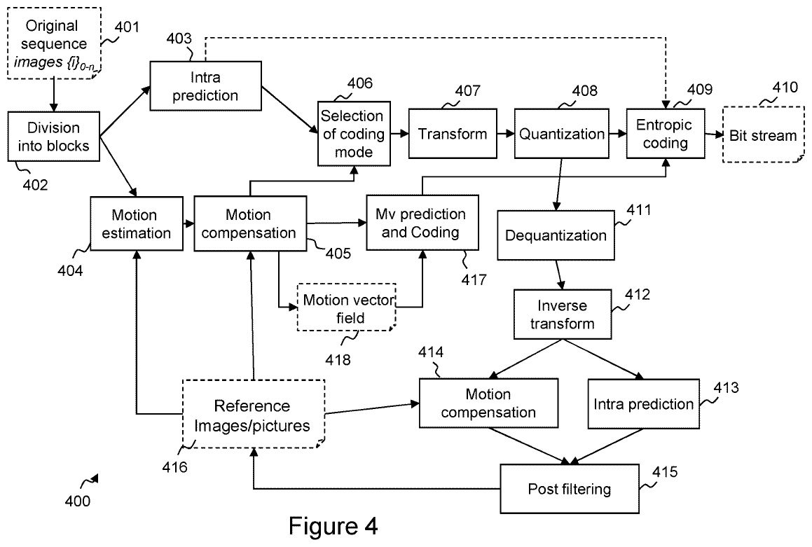

FIG. 4 illustrates a block diagram of an encoder according to at least one embodiment of the invention. The encoder is represented by connected modules, each module being adapted to implement, for example in the form of programming instructions to be executed by the CPU 311 of device 300, at least one corresponding step of a method implementing at least one embodiment of encoding an image of a sequence of images according to one or more embodiments of the invention.

An original sequence of digital images i0 to in 401 is received as an input by the encoder 400. Each digital image is represented by a set of samples, sometimes also referred to as pixels (hereinafter, they are referred to as pixels).

A bitstream 410 is output by the encoder 400 after implementation of the encoding process. The bitstream 410 comprises a plurality of encoding units or slices, each slice comprising a slice header for transmitting encoding values of encoding parameters used to encode the slice and a slice body, comprising encoded video data.

The input digital images i0 to in 401 are divided into blocks of pixels by module 402. The blocks correspond to image portions and may be of variable sizes (e.g. 4×4, 8×8, 16×16, 32×32, 64×64, 128×128 pixels and several rectangular block sizes can be also considered). A coding mode is selected for each input block. Two families of coding modes are provided: coding modes based on spatial prediction coding (Intra prediction), and coding modes based on temporal prediction (Inter coding, Merge, SKIP). The possible coding modes are tested.

Module 403 implements an Intra prediction process, in which the given block to be encoded is predicted by a predictor computed from pixels of the neighbourhood of said block to be encoded. An indication of the selected Intra predictor and the difference between the given block and its predictor is encoded to provide a residual if the Intra coding is selected.

Temporal prediction is implemented by motion estimation module 404 and motion compensation module 405. Firstly a reference image from among a set of reference images 416 is selected, and a portion of the reference image, also called reference area or image portion, which is the closest area (closest in terms of pixel value similarity) to the given block to be encoded, is selected by the motion estimation module 404. Motion compensation module 405 then predicts the block to be encoded using the selected area. The difference between the selected reference area and the given block, also called a residual block, is computed by the motion compensation module 405. The selected reference area is indicated using a motion vector.

Thus, in both cases (spatial and temporal prediction), a residual is computed by subtracting the predictor from the original block.

In the INTRA prediction implemented by module 403, a prediction direction is encoded. In the Inter prediction implemented by modules 404, 405, 416, 418, 417, at least one motion vector or data for identifying such motion vector is encoded for the temporal prediction.

Information relevant to the motion vector and the residual block is encoded if the Inter prediction is selected. To further reduce the bitrate, assuming that motion is homogeneous, the motion vector is encoded by difference with respect to a motion vector predictor. Motion vector predictors from a set of motion information predictor candidates is obtained from the motion vectors field 418 by a motion vector prediction and coding module 417.

The encoder 400 further comprises a selection module 406 for selection of the coding mode by applying an encoding cost criterion, such as a rate-distortion criterion. In order to further reduce redundancies a transform (such as DCT) is applied by transform module 407 to the residual block, the transformed data obtained is then quantized by quantization module 408 and entropy encoded by entropy encoding module 409. Finally, the encoded residual block of the current block being encoded is inserted into the bitstream 410.

The encoder 400 also performs decoding of the encoded image in order to produce a reference image (e.g. those in Reference images/pictures 416) for the motion estimation of the subsequent images. This enables the encoder and the decoder receiving the bitstream to have the same reference frames (reconstructed images or image portions are used). The inverse quantization (“dequantization”) module 411 performs inverse quantization (“dequantization”) of the quantized data, followed by an inverse transform by inverse transform module 412. The intra prediction module 413 uses the prediction information to determine which predictor to use for a given block and the motion compensation module 414 actually adds the residual obtained by module 412 to the reference area obtained from the set of reference images 416.

Post filtering is then applied by module 415 to filter the reconstructed frame (image or image portions) of pixels. In the embodiments of the invention an SAO loop filter is used in which compensation offsets are added to the pixel values of the reconstructed pixels of the reconstructed image. It is understood that post filtering does not always have to performed. Also, any other type of post filtering may also be performed in addition to, or instead of, the SAO loop filtering.

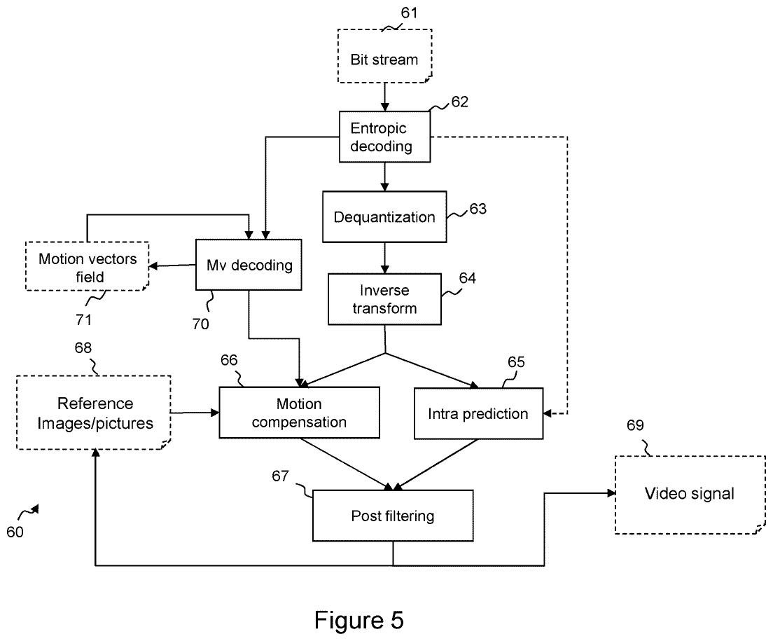

FIG. 5 illustrates a block diagram of a decoder 60 which may be used to receive data from an encoder according an embodiment of the invention. The decoder is represented by connected modules, each module being adapted to implement, for example in the form of programming instructions to be executed by the CPU 311 of device 300, a corresponding step of a method implemented by the decoder 60.

The decoder 60 receives a bitstream 61 comprising encoded units (e.g. data corresponding to a block or a coding unit), each one being composed of a header containing information on encoding parameters and a body containing the encoded video data. As explained with respect to FIG. 4, the encoded video data is entropy encoded, and the motion vector predictors' indexes are encoded, for a given block, on a predetermined number of bits. The received encoded video data is entropy decoded by module 62. The residual data are then dequantized by module 63 and then an inverse transform is applied by module 64 to obtain pixel values.

The mode data indicating the coding mode are also entropy decoded and based on the mode, an INTRA type decoding or an INTER type decoding is performed on the encoded blocks (units/sets/groups) of image data.

In the case of INTRA mode, an INTRA predictor is determined by intra prediction module 65 based on the intra prediction mode specified in the bitstream.

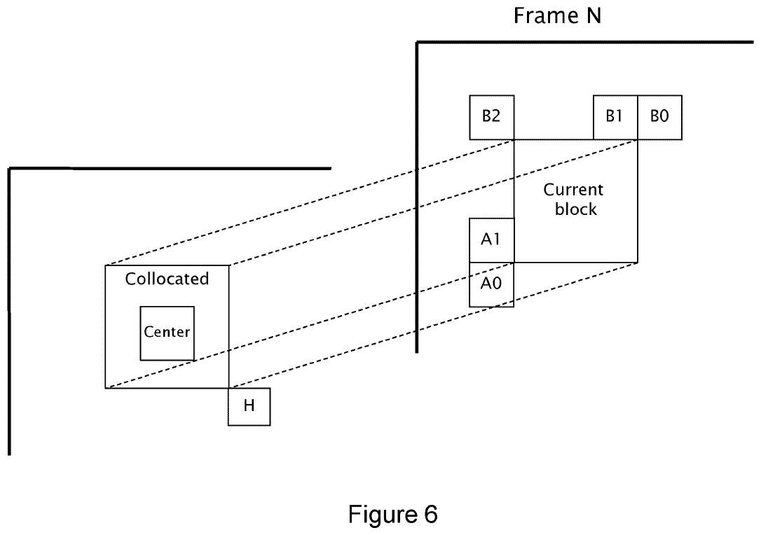

If the mode is INTER, the motion prediction information is extracted from the bitstream so as to find (identify) the reference area used by the encoder. The motion prediction information comprises the reference frame index and the motion vector residual. The motion vector predictor is added to the motion vector residual by motion vector decoding module 70 in order to obtain the motion vector. The various motion predictor tools used in VVC are discussed in more detail below with reference to FIGS. 6-10.

Motion vector decoding module 70 applies motion vector decoding for each current block encoded by motion prediction. Once an index of the motion vector predictor for the current block has been obtained, the actual value of the motion vector associated with the current block can be decoded and used to apply motion compensation by module 66. The reference image portion indicated by the decoded motion vector is extracted from a reference image 68 to apply the motion compensation 66. The motion vector field data 71 is updated with the decoded motion vector in order to be used for the prediction of subsequent decoded motion vectors.

Finally, a decoded block is obtained. Where appropriate, post filtering is applied by post filtering module 67. A decoded video signal 69 is finally obtained and provided by the decoder 60.

### Motion Prediction (INTER) Modes

HEVC uses 3 different INTER modes: the Inter mode (Advanced Motion Vector Prediction (AMVP)), the “classical” Merge mode (i.e. the “non-Affine Merge mode” or also known as “regular” Merge mode) and the “classical” Merge Skip mode (i.e. the “non-Affine Merge Skip” mode or also known as “regular” Merge Skip mode). The main difference between these modes is the data signalling in the bitstream. For the Motion vector coding, the current HEVC standard includes a competitive based scheme for Motion vector prediction which was not present in earlier versions of the standard. It means that several candidates are competing with the rate distortion criterion at encoder side in order to find the best motion vector predictor or the best motion information for respectively the Inter or the Merge modes (i.e. the “classical/regular” Merge mode or the “classical/regular” Merge Skip mode). An index corresponding to the best predictors or the best candidate of the motion information is then inserted in the bitstream, together with a ‘residual’ which represents the difference between the predicted value and the actual value. The decoder can derive the same set of predictors or candidates and uses the best one according to the decoded index. Using the residual, the decoder can then recreate the original value.

In the Screen Content Extension of HEVC, the new coding tool called Intra Block Copy (IBC) is signalled as any of those three INTER modes, the difference between IBC and the equivalent INTER mode being made by checking whether the reference frame is the current one. This can be implemented e.g. by checking the reference index of the list L0, and deducing this is Intra Block Copy if this is the last frame in that list. Another way to do is comparing the Picture Order Count of current and reference frames: if equal, this is Intra Block Copy.

The design of the derivation of predictors and candidates is important in achieving the best coding efficiency without a disproportionate impact on complexity. In HEVC two motion vector derivations are used: one for Inter mode (Advanced Motion Vector Prediction (AMVP)) and one for Merge modes (Merge derivation process—for the classical Merge mode and the classical Merge Skip mode). The following describes the various motion predictor modes used in VVC.

FIG. 6 show the labelling scheme used herein to describe blocks situated relative to a current block (i.e. the block currently being en/decoded) between frames (FIG. 6).

### VVC Merge Modes

In VVC several inter modes have been added compared to HEVC. In particular, new Merge modes have been added to the regular Merge mode of HEVC.

### Affine Mode (SubBlock Mode)

In HEVC, only translation motion model is applied for motion compensation prediction (MCP). While in the real world, there are many kinds of motion, e.g. zoom in/out, rotation, perspective motions and other irregular motions.

In the JEM, a simplified affine transform motion compensation prediction is applied and the general principle of Affine mode is described below based on an extract of document JVET-G1001 presented at a JVET meeting in Torino at 13-21 Jul. 2017. This entire document is hereby incorporated by reference insofar as it describes other algorithms used in JEM.

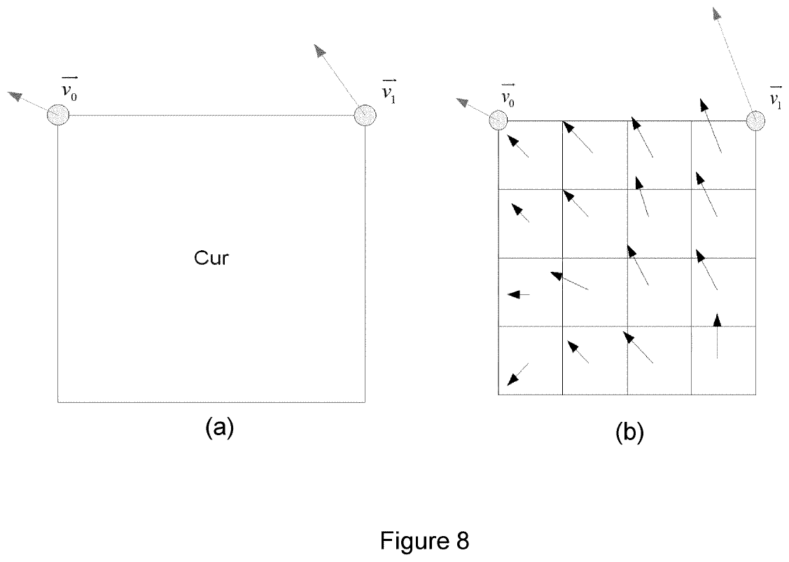

As shown in FIG. 8(a), the affine motion field of the block is described by two control point motion vectors.

The affine mode is a motion compensation mode like the Inter modes (AMVP, “classical” Merge, or “classical” Merge Skip). Its principle is to generate one motion information per pixel according to 2 or 3 neighbouring motion information. In the JEM, the affine mode derives one motion information for each 4×4 block as depicted in FIG. 8(a) (each square is a 4×4 block, and the whole block in FIG. 8(a) is a 16×16 block which is divided into 16 blocks of such square of 4×4 size—each 4×4 square block having a motion vector associated therewith). The Affine mode is available for the AMVP mode and the Merge modes (i.e. the classical Merge mode which is also referred to as “non-Affine Merge mode” and the classical Merge Skip mode which is also referred to as “non-Affine Merge Skip mode”), by enabling the affine mode with a flag.

In the VVC specification the Affine Mode is also known as SubBlock mode; these terms are used interchangeably in this specification.

The subblock Merge mode of VVC contains a subblock-based temporal merging candidates, which inherit the motion vector field of a block in a previous frame pointed by a spatial motion vector candidate. This subblock candidate is followed by inherited affine motion candidate if the neighboring blocks have been coded with an inter affine mode of subblock merge and then some as constructed affine candidates are derived before some zero Mv candidate.

### CIIP

In addition to the regular Merge mode and subblock Merge mode, the VVC standard contains also the Combined Inter Merge/Intra prediction (CIIP) also known as Multi-Hypothesis Intra Inter (MHII) Merge mode.

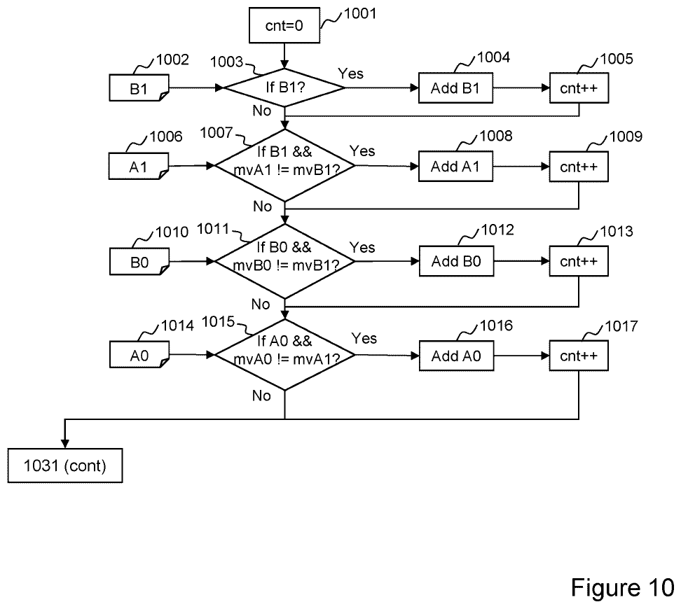

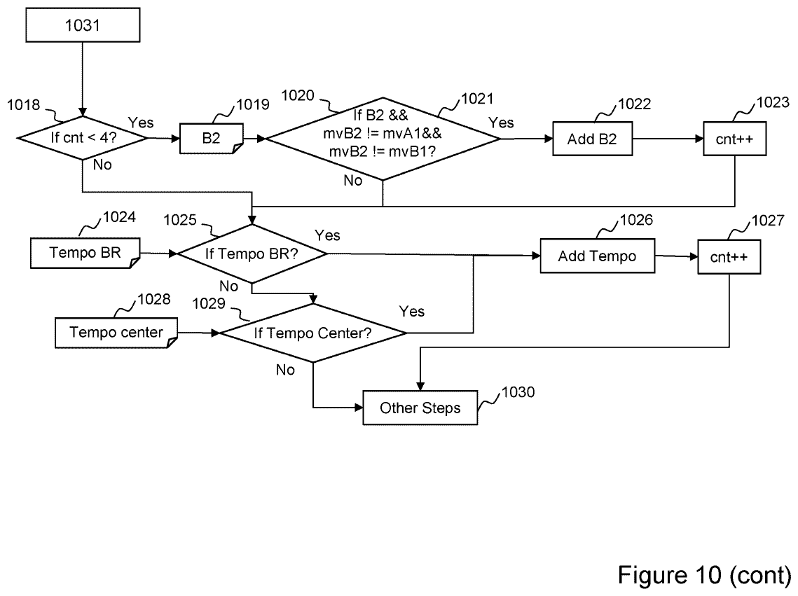

The Combined Inter Merge/Intra prediction (CIIP) Merge can be considered as a combination of the regular Merge mode and the Intra mode and is described below with reference to FIG. 10. The block predictor for the current block (1001) of this mode is an average between a Merge predictor block and an Intra predictor block as depicted in FIG. 10. The Merge predictor block is obtained with exactly the same process of the Merge mode so it is a temporal block (1002) or bi-predictor of 2 temporal blocks. As such, a Merge index is signalled for this mode in the same manner as the regular Merge mode. The Intra predictor block is obtained based on the neighbouring sample (1003) of the current block (1001). The amount of available Intra modes for the current block is however limited compared to an Intra block. Moreover, there is no Chroma Intra predictor block signalled for a CHIP block. The Chroma predictor is equal to the Luma predictor. As a consequence, 1, 2 or 3 bits are used to signal the Intra predictor for a CIIP block.

The CHIP block predictor is obtained by a weighted average of the Merge block predictor and the Intra block predictor. The weighting of the weighted average depends on the block size and/or the Intra predictor block selected.

The obtained CIIP predictor is then added to the residual of the current block to obtain the reconstructed block. It should be noted that the CIIP mode is enabled only for non-Skipped blocks. Indeed, use of the CIIP Skip typically results in losses in compression performance and an increase in encoder complexity. This is because the CIIP mode has often a block residual in opposite to the other Skip mode. Consequently its signalling for the Skip mode increases the bitrate.—when the current CU is Skip, the CIIP is avoided. A consequence of this restriction is that the CIIP block can't have a residual containing only 0 value as it is not possible to encode a VVC block residual equal to 0. Indeed, in VVC the only way to signal a block residual equal to 0 for a Merge mode is to use the Skip mode, this is because the CU CBF flag is inferred to be equal to true for Merge modes. And when this CBF flag is true, the block residual can't be equal to 0.

In such a way, CIIP should be interpreted in this specification as being a mode which combines features of Inter and Intra prediction, and not necessarily as a label given to one specific mode.

The CIIP used the same Motion vector candidates list as the regular Merge mode.

### MMVD

The MMVD MERGE mode is a specific regular Merge mode candidate derivation. It can be considered as an independent Merge candidates list. The selected MMVD Merge candidate, for the current CU, is obtained by adding an offset value to one motion vector component (mvx or mvy) to an initial regular Merge candidate. The offset value is added to the motion vector of the first list L0 or to the motion vector of the second list L1 depending on the configuration of these reference frames (both backward, both forward or forward and backward). The initial Merge candidate is signalled thanks to an index. The offset value is signalled thanks to a distance index between the 8 possible distances (¼-pel, ½-pel, 1-pel, 2-pel, 4-pel, 8-pel, 16-pel, 32-pel) and a direction index giving the x or the y axis and the sign of the offset.

In VVC, only the 2 first candidates of the regular Merge list are used for the MMVD derivation and signalling by one flag.

### Geometric Partitioning Mode

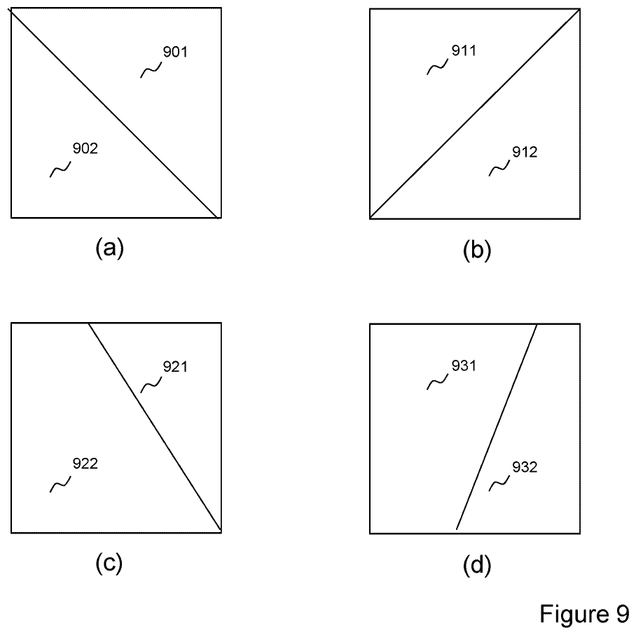

The Geometric (GEO) MERGE mode is a particular bi-prediction mode. FIG. 9 illustrates this particular block predictor generation. The block predictor contains one triangle from a first block predictor (901 or 911) and a second triangle from a second block predictor (902 or 912). But several other possible splits of the block are possible as depicted in FIG. 9(c) and FIG. 9(d). The Geometric Merge should be interpreted in this specification as being a mode which combines features of two Inter non square predictors, and not necessarily as a label given to one specific mode.

Each partition (901 or 902), in the example of FIG. 9(a), has a motion vector candidate which is a unidirectional candidate. And for each partition an index is signalling to obtain at decoder the corresponding motion vector candidate in a list of unidirectional candidates. And the first and the second can't use the same candidate. This list of candidates comes from the regular Merge candidates list where for each candidate, one of the 2 components (L0 or L1) have been removed.

### IBC

In VVC, it is also possible to enable the Intra block Copy (IBC) merge mode. IBC has an independent merge candidate derivation process.

### Other Motion Information Improvements

### DMVR

The decoder side motion vector derivation (DMVR), in VVC, increases the accuracy of the MVs of the Merge mode. For this method, a bilateral-matching (BM) based decoder side motion vector refinement is applied. In this bi-prediction operation, a refined MV is searched around the initial MVs in the reference picture list L0 and reference picture list L1. The BM method calculates the distortion between the two candidate blocks in the reference picture list L0 and list L1.

### BDOF

VVC integrates also a bi-directional optical flow (BDOF) tool. BDOF, previously referred to as BIO, is used to refine the bi-prediction signal of a CU at the 4×4 subblock level. BDOF is applied to a CU if it satisfies several conditions, especially if the distances (i.e. Picture Order Count (POC) difference) from two reference pictures to the current picture are the same.

As its name indicates, the BDOF mode is based on the optical flow concept, which assumes that the motion of an object is smooth. For each 4×4 subblock, a motion refinement (v_x, v_y) is calculated by minimizing the difference between the L0 and L1 prediction samples. The motion refinement is then used to adjust the bi-predicted sample values in the 4×4 subblock.

### PROF

Similarly, Prediction refinement with optical flow (PROF) is used for affine mode.

AMVR and hpelIfIdx

VVC also includes Adaptive Motion Vector Resolution (AMVR). AMVR allows the motion vector difference of the CU to be coded in different precision. For example for AMVP mode: quarter-luma-sample, half-luma-sample, integer-luma-sample or four-luma-sample are considered. The following table of the VVC specification gives the AMVR shift based on different syntax elements.

| | | AmvrShift | | |
|---|---|---|---|---|
| | | | | inter_affine_flag[ x0 ][ y0 ] = =0 |
| | | | | && |
| | | inter_affine_flag[ x0 | CuPredMode[ chType ][ x0 | CuPredMode[ chType ][ x0 ][ y0 ] |
| amvr_flag | amvr_precision_idx | ][ y0 ] = = 1 | ][ y0 ] = = MODE_IBC ) | != MODE_IBC |
| 0 | — | 2 (¼ luma sample) | — | 2 (¼ luma sample) |
| 1 | 0 | 0 ( 1/16 luma sample) | 4 (1 luma sample) | 3 (½ luma sample) |
| 1 | 1 | 4 (1 luma sample) | 6 (4 luma samples) | 4 (1 luma sample) |
| 1 | 2 | — | — | 6 (4 luma samples) |

AMVR can have an impact on the coding of the other modes than those using motion vector differences coding as the different Merge mode. Indeed, for some candidates the parameter hpelIfIdx, which represent an index on the luma interpolation filter for half pel precision, is propagated for some Merge candidate. For AMVP mode, for example, the hpelIfIdx is derived as follows:

$$hpelIfdx = AmvrShift == 3 ? 1 : 0$$

Bi-Prediction with CU-Level Weight (BCW)

In VVC, the bi-prediction mode with CU-level weight (BCW) is extended beyond simple averaging (as performed in HEVC) to allow weighted averaging of the two prediction signals P₀ and P₁ according to the following formula.

$${P}_{bi - pred} = ( ( 8 - w ) * {P}_{0} + w * {P}_{1} + 4 ) ≫ 3$$

Five weights are allowed in the weighted averaging bi-prediction, where w∈{−2, 3, 4, 5, 10}.

For a non-merge CU, the weight index, bcwIndex, is signalled after the motion vector difference.

For a Merge CU, the weight index is inferred from neighbouring blocks based on the merge candidate index.

BCW is used only for CUs with 256 or more luma samples. Moreover, for low-delay pictures, all 5 weights are used. And for non-low-delay pictures, only 3 weights (w∈{3,4,5}) are used.

### Regular Merge List Derivation

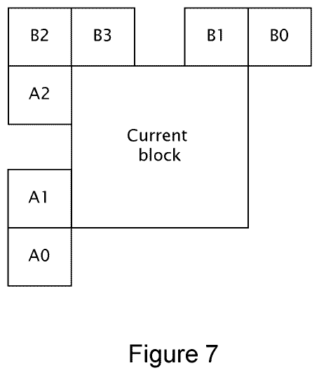

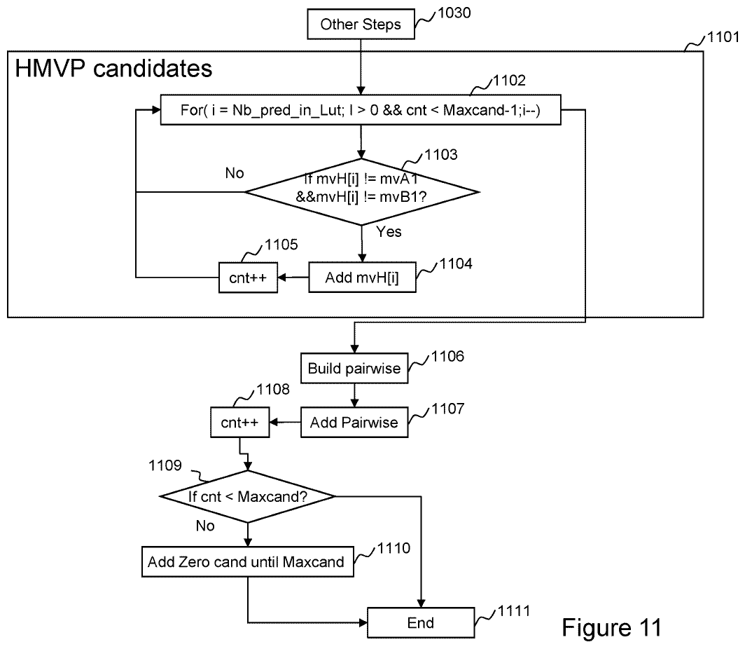

In VVC, the regular Merge list is derived as in FIG. 10 and FIG. 11. First the spatial candidates B1 (1002), A1 (1006), B0 (1010), A0 (1014) (as depicted in FIG. 7) are added if they exist. And a partial redundancies are performed, between the motion information of A1 and B1 (1007) to add A1 (1008), between the motion information of B0 and B1 (1011) to add B0 (1012) and between the motion information of A0 and A1 (1015) to add A0 (1016).

When a Merge candidate is added, the variable cnt is incremented (1015, 1009, 1013, 1017, 1023, 1027, 1115, 1108).

If the number of candidates in the list (cnt) is strictly inferior to 4 (1018), the candidate B2 (1019) is added (1022) if it has not the same motion information as A1 and B1 (1021).

Then the temporal candidate is added. The bottom right candidate (1024), if it is available (1025) is added (1026), otherwise the center temporal candidate (1028) is added (1026) if it exists (1029).

Then the history based (HMVP) are added (1101), if they have not the same motion information as A1 and B1 (1103). In addition the number of history based candidates can't exceed the maximum number of candidates minus 1 of the Merge candidates list (1102). So after the history based candidates there is at least one position missing in the merge candidates list.

Then, if the number of candidates in the list is at least 2, the pairwise candidate is built (1106) and added in the Merge candidates list (1107).

Then if there are empty positions (1109) in the Merge candidates list, the zero candidates are added (1110).

For spatial and history-based candidates, the parameters the parameters BCWidx and useAltHpelIf are set equal to the related parameters of the candidates. For temporal and zero candidates they are set equal to the default value, 0. These default values in essence disable the method.

For the pairwise candidate, BCWidx is set equal to 0 and hpelIfIdxp is set equal to the hpelIfIdxp of the first candidate if it is equal to the hpelIfIdxp of the second candidate, and to 0 otherwise.

### Pairwise Candidate Derivation

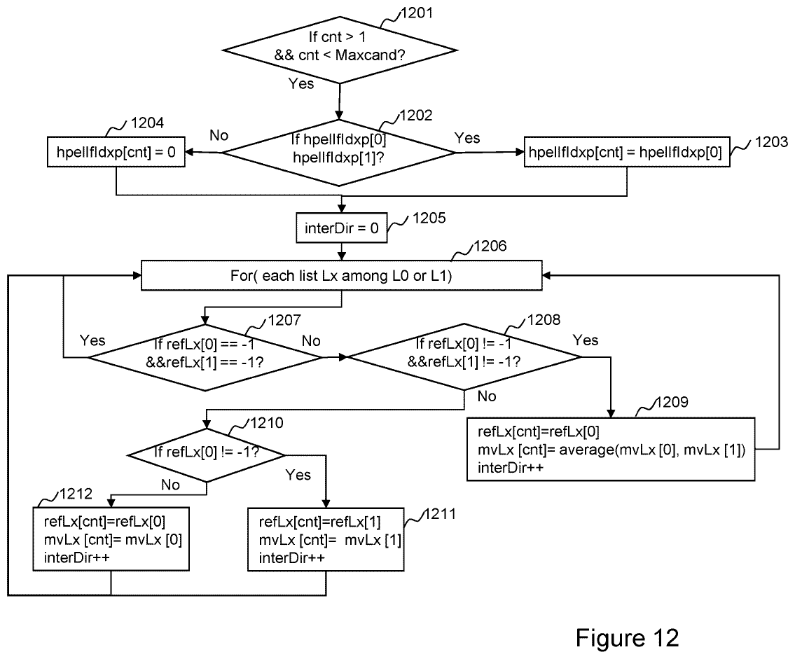

The pairwise candidate is built (1106) according to the algorithm of FIG. 12. As depicted, when 2 candidates are in the list (1201), the hpelIfIdxp is derived as mentioned previously (1204, 1202, 1203). Then the inter direction (interDir) is set equal to 0 (1205). For each list, L0 and L1, If at least one reference frame is valid (different to −1) (1207), the parameters will be set. If both are valid (1208), the mv information for this candidate is derived (1209) and set equal to the reference frame of the first candidate and the motion information is the average between the 2 motion vectors for this list and the variable interDir is incremented. If only one of the candidates has motion information for this list (1210), the motion information for the pairwise candidate is set equal to this candidate (1212, 1211) and the inter direction variable interDir is incremented.

### ECM

Since the end of the standardization of VVC v1, JVET has launched an exploration phase by establishing an exploration software (ECM). It gathers additional tools and improvements of existing tools on top of the VVC standard to target better coding efficiency. The different additional tools compared to VVC are described in JVET-X2025.

### ECM Merge Modes

Among all tools added, some additional Merge modes have been added. The Affine MMVD signal offsets for the Merge affine candidate as the MVVD coding for the regular Merge mode. Similarly, the GEO MMVD was also added. The CIIP PDPC is an extension of the CIIP. And 2 template matching Merge mode have been added: the regular template matching and the GEO template matching.

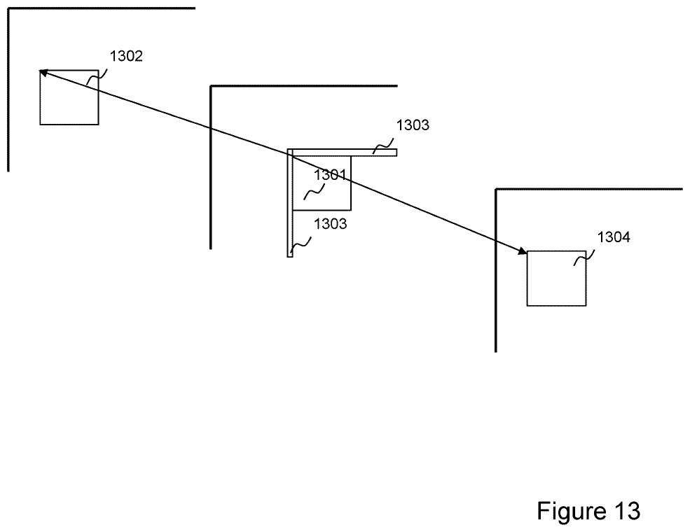

The regular template matching is based on the template matching estimation as depicted in FIG. 13. At decoder side, for the candidate corresponding to the related Merge index and for both lists (L0, L1) available, a motion estimation based on the neighboring samples of the current block (1301) and based on the neighboring samples of the multiple corresponding block positions, a cost is computed and the motion information which minimized the cost is selected. The motion estimation is limited by a search range and several restrictions on this search range are also used to reduce the complexity.

In the ECM, the regular template matching candidates list is based on the regular Merge list but some additional steps and parameters have been added which means different Merge candidates lists for a same block may be generated. Moreover, only 4 candidates are available for the template matching regular Merge candidates list compared to the 10 candidates for the regular Merge candidates list in the ECM with common tests conditions defined by JVET.

### Regular Merge List Derivation in ECM

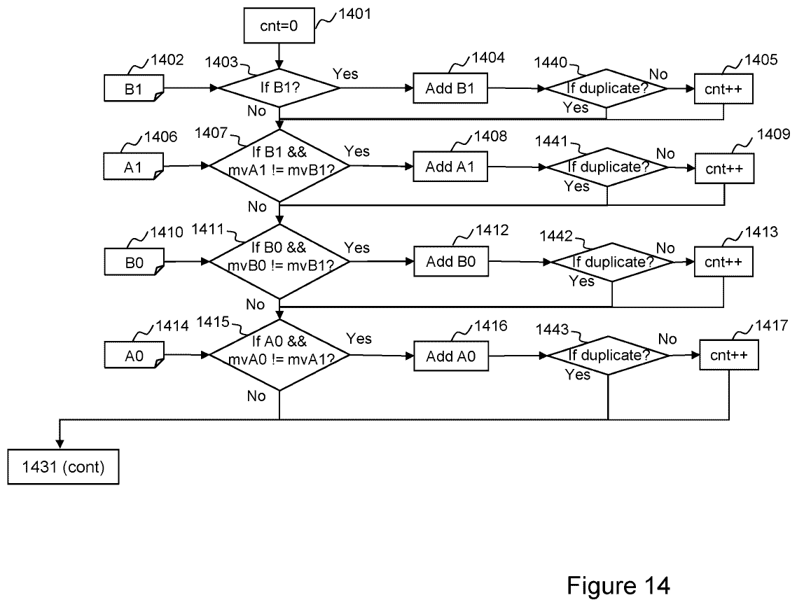

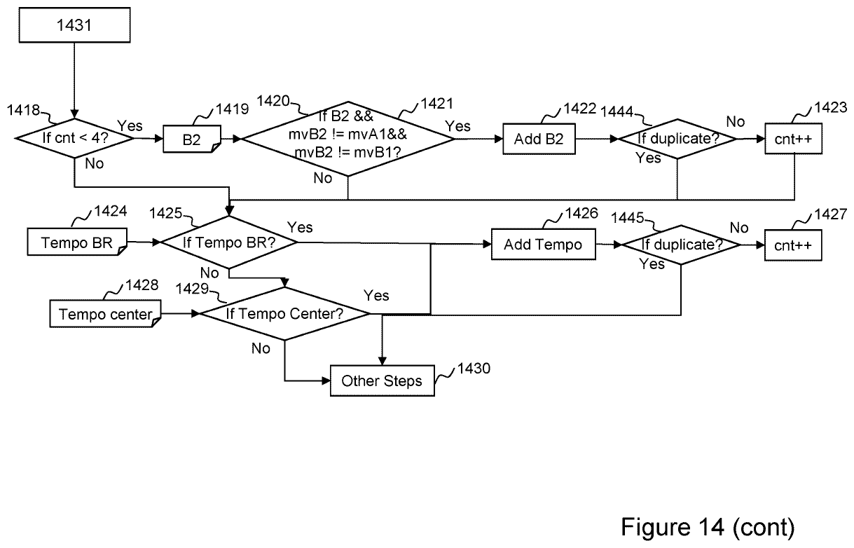

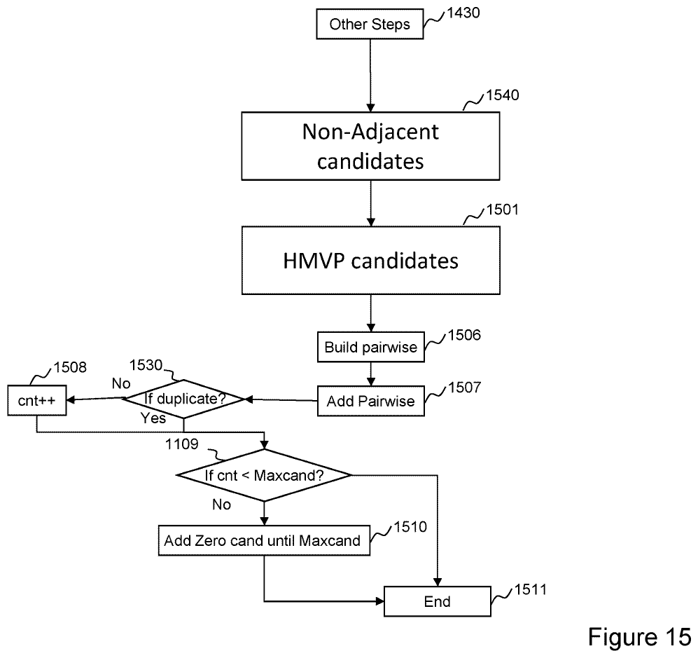

In the ECM, the regular Merge list derivation have been updated. FIGS. 14 and 15 show this update based on respectively FIGS. 10 and 11. But for clarity, the module for the history based candidates (1101) have been summarized in (1501).

In this FIG. 15, a new type of merge candidates has been added: the non-adjacent candidates (1540). These candidates come from blocks spatially located in the current frame but not the adjacent ones, as the adjacent are the spatial candidates. They are selected according to a distance and a direction. As for the history based the list of adjacent candidates can be added until that the list reaches the maximum number of candidate minus 1, in order that the pairwise can still be added.

### Zero Candidates

If the list still hasn't reached the maximum number of candidates (Maxcand) zero candidates are added to the list. The zero candidates are added according to the possible reference frames or pair of reference frames. The following pseudo code gives the derivation of such candidates:

```
int iNumRefIdx =slice.isInterB( )?min(MaxRefL0, MaxRefL1):
MaxRefL0;
int r=0
int refcnt=0;
while (nbCand < Maxcand)
  {
    if (slice.isInterB( ))
    {
    addZero(L0(Mv(0,0),Refix(r)), L1(Mv(0,0),Refix(r)) );
    }
    else
    {
    addZero(Mv(0,0),Refix(r));
    }
    nbCand++;
    if (refcnt == iNumRefIdx − 1)
    {
      r = 0;
    }
    else
    {
      ++r;
      ++refcnt;
    }
  }
```

This pseudo code can be summarized as: for each reference frame index (uni-direction), or pair of reference indexes (bi-prediction), a zero candidate is added. When all are added, only zero candidates with reference frames indexes 0 are added until that the number of candidates reaches its maximum value. In such a way, the Merge list can include multiple zero candidates. Indeed, it has been surprisingly found that this occurs frequently in real video sequences, particularly at the beginnings of slices or frames and sequences.

In the recent modification of the derivation of the merge candidates, the number of the candidates in the list can be superior to the maximum number of candidates in the final list Maxcand. Yet this number of candidates in the initial list, MaxCandInitialList, is used for the derivation. Consequently, the Zero candidates are added until MaxCandInitialList and not until Maxcand.

### BM Merge Mode

The BM Merge is Merge mode dedicated to the Adaptive decoder side motion vector refinement method which is an extension of multi-pass DMVR of the ECM. As described in JVET-X2025, this mode is equivalent to 2 Merge modes to refine the MV only in one direction. So, one Merge mode for L0 and one Merge mode for L1. So, the BM Merge is enabled only when the DMVR conditions can be enabled. For these two Merge modes only one list of Merge candidates is derived and all candidates respect the DMVR conditions.

The Merge candidates for the BM Merge mode are derived from spatial neighbouring coded blocks, TMVPs, non-adjacent blocks, HMVPs, pair-wise candidate, in a similar manner as for the regular Merge mode. A difference is that only those meet DMVR conditions are added into the candidate. Merge index is coded in a similar manner as for regular Merge mode.

### AMVP Merge Mode

The AVMP Merge mode, also known as the bi-directional predictor, is defined as the following in JVET-X2025: It is composed of an AMVP predictor in one direction and a Merge predictor in the other direction. The mode can be enabled to a coding block when the selected Merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the Merge MV candidate and AMVP MVP as a starting point. Otherwise, if template matching functionality is enabled, template matching MV refinement is applied to the Merge predictor or the AMVP predictor which has a higher template matching cost.

AMVP part of the mode is signalled as a regular uni-directional AMVP, i.e. reference index and MVD are signalled, and it has a derived MVP index if template matching is used or MVP index is signalled when template matching is disabled.

For AMVP direction LX, where X can be 0 or 1, the Merge part in the other direction (1-LX) is implicitly derived by minimizing the bilateral matching cost between the AMVP predictor and a Merge predictor, i.e. for a pair of the AMVP and a Merge motion vectors. For every Merge candidate in the Merge candidate list which has that other direction (1-LX) motion vector, the bilateral matching cost is calculated using the Merge candidate MV and the AMVP MV. The Merge candidate with the smallest cost is selected. The bilateral matching refinement is applied to the coding block with the selected Merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

### MVD Sign Prediction

The sign prediction method is described in JVET-X0132. The motion vector difference sign prediction can be applied in regular inter modes if the motion vector difference contains non-zero component. In the current ECM version, it is applied for AMVP, Affine MVD and SMVD modes. Possible MVD sign combinations are sorted according to template matching cost and index corresponding to the true MVD sign is derived and coded with context model. At decoder side, the MVD signs are derived as following: 1/Parse the magnitude of MVD components. 2/Parse context-coded MVD sign prediction index. 3/Build MV candidates by creating combination between possible signs and absolute MVD value and add it to the MV predictor. 4/Derive MVD sign prediction cost for each derived MV based on template matching cost and sort. 5/Use MVD sign prediction index to pick the true MVD sign. 6/Add the true MVD to the MV predictor for final MV.

### TIMD

The intra prediction, fusion for template-based intra mode derivation (TIMD) is described as the following in JVET-X2025: For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

### Duplicate Check

In FIGS. 14 and 15, a duplicate check for each candidate was added (1440, 1441, 1442, 1443, 1444, 1445, and 1530). But, the duplicate is also for the Non-adjacent candidates (1540) and for the history based candidates (1501). It consists in comparing the motion information of the current candidate of the index cnt to the motion information of each other previous candidates. When this motion information is equal, it is considered as duplicate and the variable cnt is not incremented. Of course the motion information means inter direction, reference frame indexes and motion vectors for each list (L0, L1). Note that zero candidates corresponding to different reference frames are not considered duplicates.

### MVTH

In the ECM, for the duplicate check a motion vector threshold was added. This parameter changes the equality check by considering that 2 motion vectors are equal if their absolute difference, for each component, is in inferior or equal to the motion vector threshold MvTh. For the regular Merge mode the MvTh is set equal to 1 which corresponds to a traditional duplicate check without motion vector threshold.

The MvTh is equal to a value which depends on the number of luma sample nbSamples in the current CU for the template matching regular Merge mode as defined as the following:

if (nbSamples < 64) MvTh = 1 << MV_FRACTIONAL =16
else if (nbSamples < 256) MvTh = 2<< MV_FRACTIONAL =32
else MvTh = 4<< MV_FRACTIONAL =64

Where MV_FRACTIONAL corresponds to the inter resolution of the codec. So, in ECM currently, the 16^{th} resolution is used so MV_FRACTIONAL is equal to 4. << is the left shift operator. And where nbSamples=Height×Width (Height and Width for the current block.

There is, for example, another threshold, MvThBDMVRMvdThreshold, used for GEO Merge derivation and also for the duplicate check of the non-adjacent candidates as described below.

```
if (nbSamples < 64)
    MvThBDMVRMvdThreshold = (1 <<
    MV_FRACTIONAL) >> 2 = 4
  else if (nbSamples < 256)
    MvThBDMVRMvdThreshold = (1 <<
    MV_FRACTIONAL) >> 1 = 8
  else
    MvThBDMVRMvdThreshold = (1 <<
    MV_FRACTIONAL) >> 0 = 16
```

### AMRC

In the ECM, in order to reduce the number of bits for the Merge index, an Adaptive Reordering of Merge Candidates with Template Matching (AMRC) was added. According to the template matching cost computed as in FIG. 13, the candidates are reordered based on the cost of each candidate. In this method only one cost is computed per candidate. This method is applied after that this list has been derived and only on the 5 first candidates of the regular Merge candidates list. It should be appreciated that the number 5 was chosen to balance the complexity of the reordering process with the potential gains, and as such a greater number (e.g. all of the candidates) may be reordered.

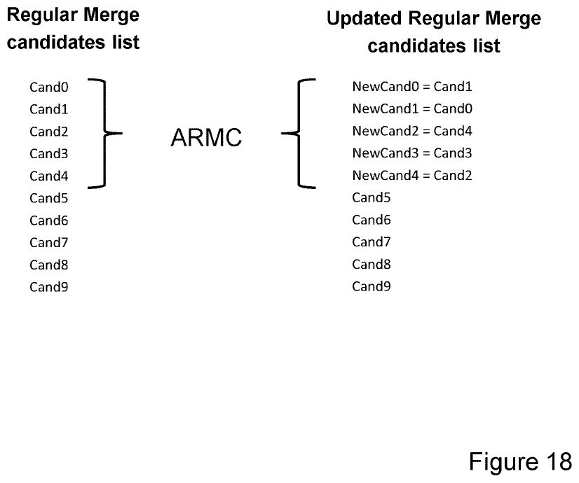

FIG. 18 gives an example of this method on a regular Merge candidate list containing candidates as in the CTC.

This method is also applied on the subblock merge mode except for the temporal candidate and on for the regular™ mode for all of the 4 candidates.

In a proposal, this method was also extended to reorder and select a candidates to be included in the final list of Merge mode candidates. For example, in JVET-X0087, all possible non-adjacent candidates (1540) and History based candidates (1501) are considered with temporal non-adjacent candidates in order to obtain a list of candidates. This list of candidates is built without considering the maximum number of candidates. This list candidates is then reordered. Only a correct number of candidates from this list are added to the final list of Merge candidates. The correct number of candidates corresponding to the first N candidates in the list. In this example, the correct number is the maximum number of candidates minus the number of spatial and temporal candidates already in the final list. In other words, the non-adjacent candidates and History based candidates are processed separately from the adjacent spatial and temporal candidates. The processed list is used to supplement the adjacent spatial and temporal Merge candidates already present in the Merge candidate list to generate a final Merge candidate list.

In JVET-X0091, ARMC is used to select the temporal candidate from among 3 temporal candidates bi-dir, L0 or L1. The selected candidate is added to the Merge candidate list.

In JVET-X0133, the Merge temporal candidate is selected from among several temporal candidates which are reordered using ARMC. In the same way, all possible Adjacent candidates are subject to ARMC and up to 9 of these candidates can be added to the list of Merge candidates.

All these proposed methods use the classical ARMC reordering the final list of merge candidates to reorder it. JVET X0087 re-uses the cost computed during the reordering of the non-adjacent and History based candidates, to avoid additional computation costs. JVET-X0133 applies a systematic reordering on all candidates on the final list of merge candidates.

### New AMRC

Since the first implementation of ARMC, the method was added to several other modes. The ARMC is applied additionally to the Regular, and Template matching Merge mode, Subblock Merge modes and also for IBC, MMVD, Affine MMVD, CIIP, CIIP with template matching and BM Merge mode. In addition, the principle of ARMC to reorder the list of candidates based on template matching cost is also applied to the AMVP Merge candidates derivation as well as for the Intra method TIMD to select the most probable predictors.

In addition, the principle is added for the sign residual prediction method for Affine MVD, AMVP and SMVD method.

There are also additional tests of the usage of this reordering for GEO Merge mode and GEO with template matching as well as for reference frame index prediction.

In addition to this almost systematic usage of the ARMC, there was several additional modifications of the derivation process for some candidates.

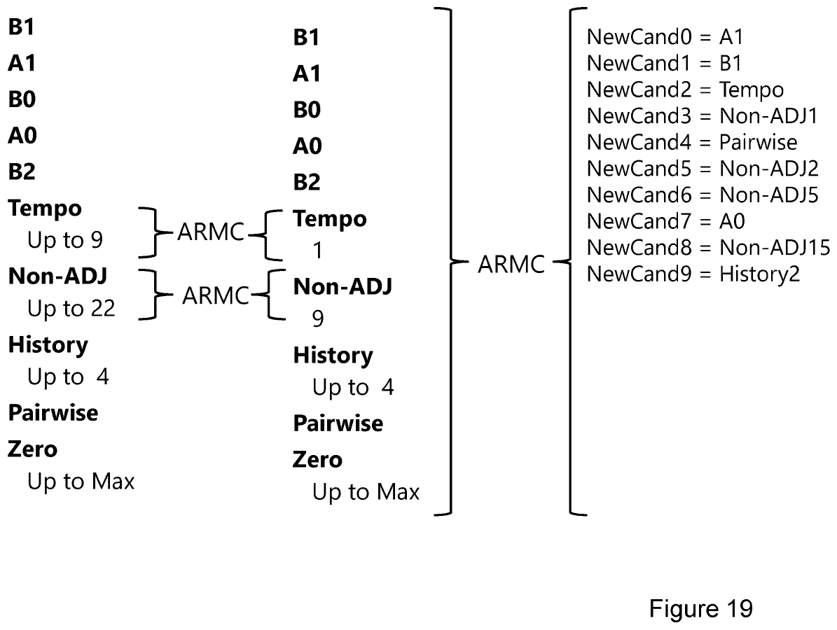

For example, the ECM4.0 derivation includes a cascading AMRC process for the candidates derivation of the regular, TM and BM merge modes as depicted for the regular and TM Merge mode in FIG. 19.

Compared to the previous Merge candidates derivation, first 10 temporal positions are checked and added to the list of the temporal candidates after a non-duplicate check. This temporal list can contain at the maximum 9 candidates. Moreover, there is a particular threshold for this temporal list as the MV threshold is always 1 and not depend on the Merge mode compared to the motion threshold uses for the Merge candidate derivation. Based on the list of maximum 9 first non-duplicate positions, the ARMC process is applied and only the first temporal candidate is added in the traditional list of Merge candidates if it is not duplicate compared to previous candidates.
In the same way the non-Adjacent spatial candidates are derived among 59 positions. The first list of non-duplicate candidates which can reach 18 candidates is derived. But the Motion Threshold is different to those used in for temporal derivation and for the rest of the list and doesn't depends on the regular or template Merge modes. It is set equal to the mv the of BDMVR. Up to 18 non-adjacent candidates are reordered and only the 9 first non-Adjacent candidate are kept and added in the Merge candidates list. Then the other candidates are added except if the list contain already the maximum number of candidates. In addition, for the TM Merge mode the maximum number of candidates in the list MaxCandInitialList is higher than the maximum number of candidates that the final list can contain Maxcand.
Then the ARMC process is applied for all candidates of the intermediate list, containing MaxCandInitialList, as depicted in FIG. 19. The maximum number of candidates Maxcand are set in the final list of candidates.
A similar modification is applied also for the BM Merge mode as the template matching Merge mode.

### ARMC Template Cost Algorithm

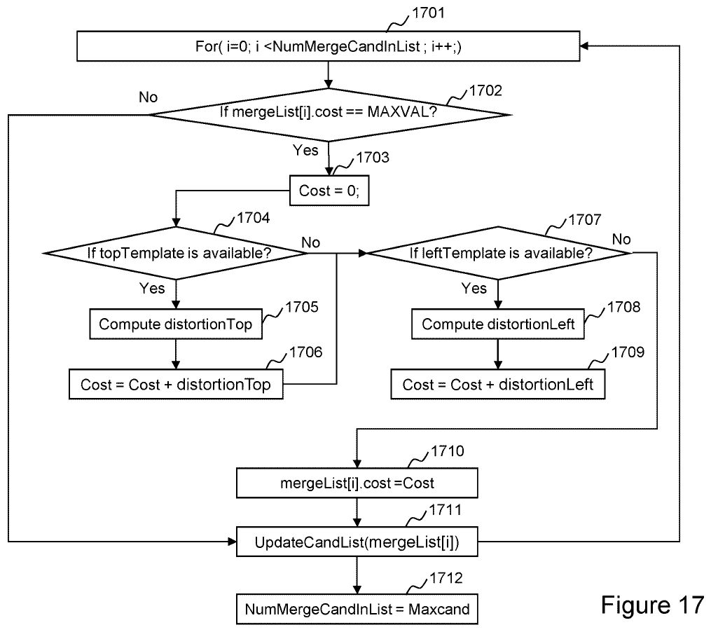

FIG. 17 illustrates the template cost computation of the ARMC method. The number of candidates considered in this process, NumMergeCandInList, is superior or equal to the maximum number that the list can contain Maxcand (1712).

For each candidate in the list (1701), if the cost was not computed during the first ARMC processes for temporal and non-adjacent candidates (1702), the cost is set equal to 0 (1703). In the implementation a cost non computed associated to a candidate “i”, mergeList [i].cost, was set equal to the maximum value MAXVAL. If the top template for the current block is available (1704), the distortion compared to the current block template is computed (1705) and added to the current cost (1706). Then or otherwise, if the left template for the current block is available (1707), the distortion compared the current block template is computed (1708) and added to the current cost (1709). Then the cost of the current Merge candidate, mergeList [i].cost, is set equal to the computed cost (1710) and the list is updated (1711). In this example we consider that the current candidate i is set to a position regarding its cost compared to the cost of the other candidates. When all candidates have been proceeded the number of candidates in the list, NumMergeCandInList, is set equal to the maximum number of possible candidates in the list Maxcand.

### Multiple Hypothesis Prediction (MHP)

The Multiple Hypothesis Prediction (MHP) was also added in the ECM. With this method it is possible to use up to four motion-compensated prediction signals per block (instead of two, as in VVC). These individual prediction signals are superimposed in order to form the overall prediction signal. The motion parameters of each additional prediction hypothesis can be signalled either explicitly by specifying the reference index, the motion vector predictor index, and the motion vector difference, or implicitly by specifying a Merge index. A separate multi-hypothesis Merge flag distinguishes between these two signalling modes.

For spatial candidates, non-adjacent Merge candidates and history based Merge candidates, the multiple hypothesis parameters values ‘addHypNeighbours’ are inherited from the candidate.

For temporal candidates, and zero candidate and pairwise candidate, the multiple hypothesis parameters values ‘addHypNeighbours’ are not keep (they are clear).

### LIC

In the ECM, the Local Illumination Compensation (LIC) have been added. It is based on a linear model for illumination changes. The linear model is computed thanks to neighboring samples of the current block and the neighboring sample of the previous blocks.

In the ECM, LIC is enabled only for unidirectional prediction. LIC is signaled by way of a flag. For the Merge modes no LIC flag is transmitted but instead the LIC flag is inherited from the merge candidates in the following manner.

For spatial candidates, Non-adjacent merge candidates and history-based Merge candidates the value of the LIC flag is inherited.

For temporal candidates, and zero candidates the LIC flag is set equal to 0.

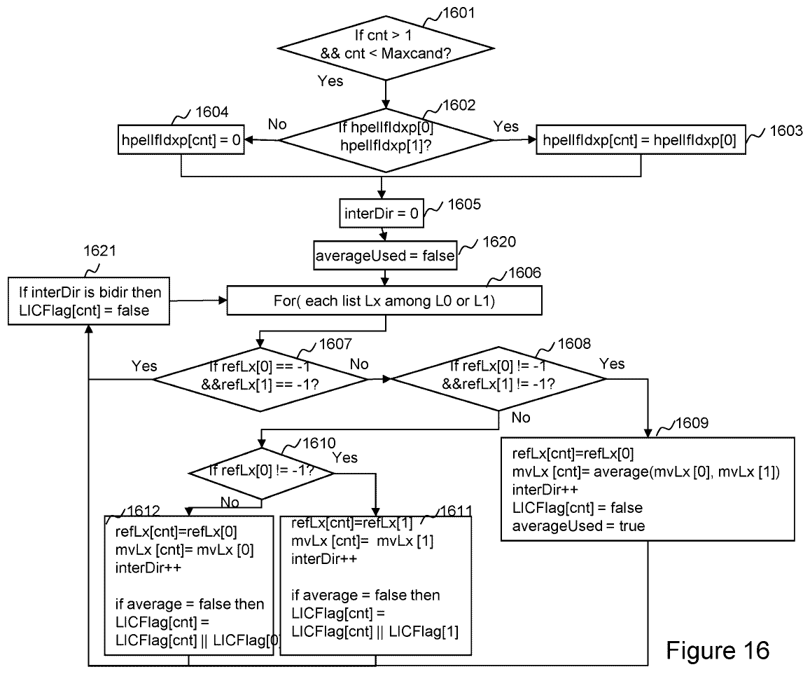

For pairwise candidates, the value of the LIC flag it is set as depicted in FIG. 16. This figure is based on FIG. 12 and modules 1620 and 1621 have been added and modules 1609, 1612 and 1611 have been updated. A variable average is set equal to false (1620), if for the current list the average for the pairwise have been computed the LIC flag for the pairwise LICFlag[cnt] is set equal to false and the variable averageUsed equals to true (1609). If only candidate have a motion information for the list (1612 1611) the LIC flag is updated if the average wasn't used. And it is set equal to a OR operation with its current value and the value of the LICflag of the candidate.

And when the pairwise candidate is Bidir (e.q. equal 3) the LIC flag is equal to false.

However, the algorithm as shown in FIG. 16 only allows the LICflag to be equal to something different to true if the 2 candidates have motion information for one list and each candidate has its own list. For example, the candidate 0 has motion information for L0 only and Candidate 1 has motion information for L1 only. In that case the LIC flag can be equal to something else different to 0 but as LIC is only for uni-direction it will never happen. So the LIC flag for the pairwise is always equal to false. Consequently the pairwise candidate can't use LIC when it is potentially needed. So this reduces the efficiency of the candidate and avoid the propagation of LIC for the following coded blocks and consequently decreases the coding efficiency.

Furthermore, the duplicate check in the ECM software introduces some inefficiencies. As depicted in FIG. 14 and FIG. 15, each candidate is added in the list and the duplicate check (1440, 1441, 1442, 1443, 1444, 1445, and 1530) has an impact only on the increment of the variable cnt (1405, 1409, 1413, 1417, 1423, 1427, 1508). In addition, as described in FIG. 16, the variable BCWidx is not initialized for the pairwise candidate. Consequently, if the last candidate added in the list was a duplicate candidate, the value BCWidx for the pairwise candidate is the value of this previous duplicate candidate. This was not the case in VVC as candidates are not added when they are considered as duplicate.

### Embodiments

As discussed above, reordering motion vector predictor candidates in a list generally means that the most likely predictors are positioned higher up the list, and as such require fewer bits to encode. However, it has been noted that this does not always occur. The following examples aim to improve the reordering process by defining certain circumstances or categories of candidates where the reordering process is not used, reduced, and/or a secondary reordering process is performed.

In the following embodiments, the list of candidates or predictors will be reordered according to a cost computed. For example, as mentioned above, several lists of Merge candidates or motion vector predictors are reordered according to template costs as well as Intra predictors.

In the following examples, the list of candidates or predictors can be Intra or Inter blocks or a list of predictors to derive something other than a predictor. For example, in the above description, the MVD sign prediction method reorder a list of possible MVD sign indexes. The present disclosure mainly focus on Merge candidates derivation.

Excluding Categories of Candidates from the Reordering Process

In one example, the list of candidates or predictors will be reordered according to a cost computed. The list derived before reordering can come from previously decoded or encoded motion information. For example, spatial positions, temporal positions, or spatial/temporal non adjacent positions, or from a list of previous decoded candidates, or candidates derived from other candidates or candidates derived from other decoded samples or estimated samples. Such candidates are chosen on the basis that their corresponding samples are likely to be correlated to the samples to be en/decoded.

The list of candidates does not reach always the maximum number of candidates that the final list can contain (Maxcand). The maximum number of candidates inside a list corresponds to the maximum index value that a decoder can decode. However, the list of candidates before reordering can contain more than this maximum and the additional candidates in this list can be removed thanks to a reordering algorithm based on cost values as described in FIG. 17. So, during the derivation the maximum candidates can be higher than the final maximum number of candidates after the reordering.

When the list of candidates does not reach the maximum number of candidates, some additional candidates are added.

Coding efficiency is improved when the candidate(s) added to reach the maximum number of candidates are not considered during the reordering process (i.e. excluded from the reordering process). This is mainly because these candidates are duplicated and when the reordering process set them at an early position (earlier than the selected/best candidate), several consecutive Merge indexes are used to signal the same candidate which increases the merge index rate or avoid the selection of the best candidate. A further reason is that, on average, these candidates are inefficient as they have no correlation with the current block especially when the list of candidates is large.

Including these as part of the reordering process is unlikely to provide a gain and would thus unnecessarily add to the complexity (in particular for large lists).

In a particularly advantageous case, the zero candidates which are added to the list are not considered for the reordering process. The advantage of this is a complexity reduction as the number of computations of cost is limited.

An additional advantage of this embodiment is a coding efficiency improvement as the zero candidates are often inefficient and when they are reordered they can take position of useful candidates and when they are duplicated zero candidates, several consecutive indexes at the beginning of the list or at the middle represent exactly the same candidate and the signaling of the others candidates after these candidates have a higher rate than it is needed.

This scenario has been found to be more likely at the start of video sequences.

The reordering process may only be applied in some coding modes. In a particularly advantageous example, the reordering process is applied for one mode on full list. The advantage is a coding efficiency improvement. Indeed, when the zero candidate is interesting in term of coding efficiency, there is at least one mode for which it is represented with a minimum number of bits.

An example of this a mode where the reordering process is not performed on the full list is the subblock Merge mode. So, the reordering process is not applied on candidates to fulfill the list as the zero candidates for the regular Merge, TM Merge, BM Merge, and IBC Merge modes.

In another example, the mode where the reordering process is applied on the full list is a mode with a number of candidates below a threshold (i.e. a small number of candidates) and/or where the zero candidates are often in the list but the number of zero candidates is low (e.g. below a threshold). A suitable threshold is 4. In other words, the reordering process is not performed on candidates set to fulfil the list as the zero candidates for modes which have a number of candidates above a threshold and/or the number of zero candidates is above a threshold.

Determining a Cost Function which Defines the Reordering Process

The accuracy of the process of determining the relative ‘cost’ of the candidates at the decoder side is a determiner of how effective the reordering process is. The following examples provide improvements to the cost determination process which result in a more accurate list, a lower complexity of calculating cost, or both.

It is important to note that the algorithm for performing the reordering based may be altered to prioritize either accuracy or complexity (speed) of the reordering process.

The examples below aim to produce an accurate indication of the relative cost while minimizing the overall complexity of the operation.

In one example, the reordering is based on cost which includes a measure between samples. A sample associated with each candidate is compared to another sample to produce a relative cost.

For example, the cost for a candidate can be computed based on neighboring samples of that predictor's block and the neighboring samples of the current block. Such samples are readily available at the decoder side.

The cost can be computed between the samples of 2 blocks predictors corresponding to the candidates in the list. For example, when a candidate is a bi-prediction candidate, the cost can be the distortion between the two blocks predictors. Bi-prediction candidates are discussed in more detail below.

The cost can be also computed compared to another candidate. For example, one other candidate can be a most probable candidate or predictor. The cost of a candidate is computed thanks to its samples and the samples of this most probable candidate.

The cost can be computed on a sub-set of neighboring samples or a sub-set of samples of the predictors. For example, if there are a plurality of neighboring samples that could be used to determine a cost, these are sampled so as to decrease the complexity of the calculation.

The cost can be computed based on samples corresponding to an image from another resolution. A high similarity with an image from a higher resolution is a good indication of a low cost (i.e. a good predictor).

The values of samples used to compute cost can be pre-processed. Given that only relative cost values are required (i.e. only the order is important) pre-processing values means a simpler calculation and is unlikely to significantly affect the efficacy of the reordering process. Depending to the pre-processing, the costs computed improves the reordering process.

In the above examples, the cost could be a measure of distortion such as Sum of Absolute Difference (SAD), Sum of Absolute Transformed Differences (SATD), Sum of Square Errors (SSE) or Structural Similarity Index Measure (SSIM).

Alternatively, the cost is a measure of distortion and a weight can be applied to this distortion. A rate or estimated rate can be also considered. Or a threshold.

The cost may also be a weighted cost where the weight differs in dependence on the type of predictor or candidate, or the candidate's initial position in the list.

Determining which Candidates are Reordered (Signalling)

When some candidates in the list are not reordered it is necessary for both the encoder and decoder to determine which candidates are excluded from reordering (or on which candidates the reordering process is performed). One way of achieving this is via additional signalling/deriving a variable which corresponds to the number of candidates which are reordered.

In one example, before that the candidates added to fulfill the list of candidates are added inside the list of candidates a variable, numMaxNonZeroCand, is set equal to the current number of candidates. Then the reordering is limited to this variable value and not to the maximum number that the list can contains. This variable may be the difference between the current number of candidates and Maxcand.

In one embodiment, the variable is encoded in a header at sequence, set of pictures, picture, slice level. This variable can be in set equal to an average of numMaxNonZeroCand for better coding efficiency. In that signaling case, this variable is preferably the difference between the current number of candidates and Maxcand. This may require fewer bits to encode as the difference (i.e. the number of candidates excluded from reordering) is likely to be lower than the current number of candidates (i.e. the number of candidates on which reordering is applied).

When the maximum number of candidates of the list is greater or equal to the maximum number of candidates that the final list can contain, this doesn't limit the computation cost.

A variation of this is to identify the first candidate added to fulfill the list by a variable and all candidates after this variable are not reordered.

This value may be used to avoid the reordering of zero candidates or to at least avoid the computation of costs for the zero candidates.

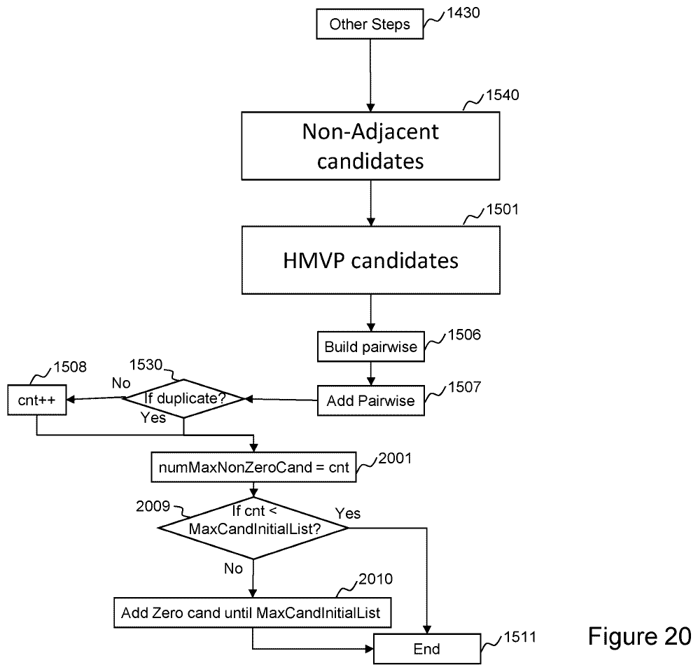

FIG. 20 illustrates this embodiment for the zero candidates. This figure is based on FIG. 15. In this figure numMaxNonZeroCand is set equal to the current number of candidates before that the zero candidates are added (2001). In addition, in this figure the Zero candidates are added until the maximum number of candidates in the initial list MaxCandInitialList (2009) (2010) instead of Maxcand. Indeed, the initial list of candidates can to be higher than the final list of candidates in the last ECM version.

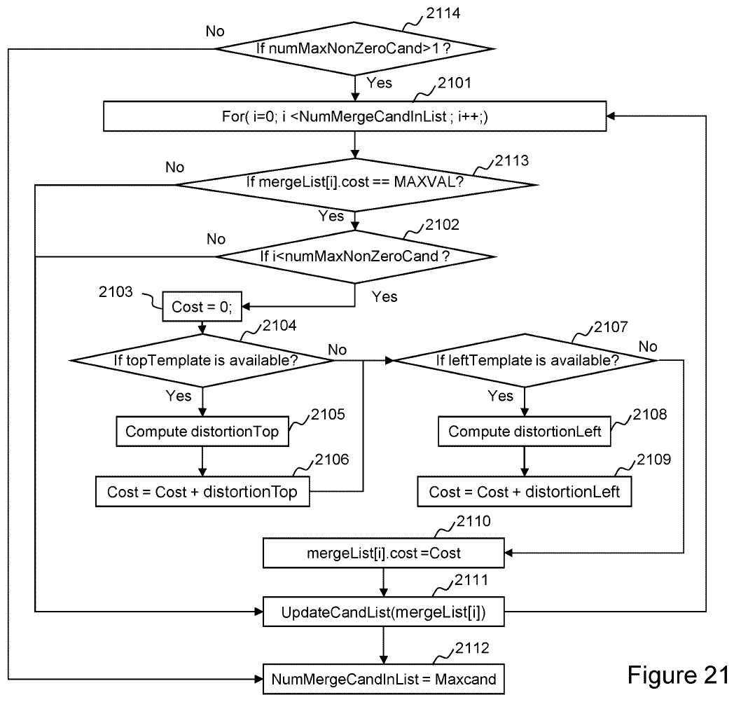

Then, as illustrated in FIG. 21, this value numMaxNonZeroCand is used to avoid the computation of costs for these candidates (2102). FIG. 21 is based on FIG. 17.

Another implementation should be to change the value of NumMergeCandInList by the variable numMaxNonZeroCand in module 2101 or 1701. This is only an implementation issue and depends on the initialization of the variables.

In an alternative example, each candidate added to fulfil the list of candidates (for example, the zero candidates) are identified by a variable. During the reordering process of all candidates of the list, the variable is used to apply or not the cost computation. In such a way, the same reordering process is applied but the non-reordered candidates are ignored by virtue of not having an associated cost.

### Processing of Non-Reordered Candidates

In an advantageous implementation of these different examples is that the candidates use to fulfil the list of candidates (e.g. as the zero candidates) are set to the end of the list. In one example, these are ordered according to the order that they have been derived in the initial list. This characteristic gives the coding efficiency as previously explained. For example, in FIG. 21 when the current number of candidates is superior to the value numMaxNonZeroCand (2113), corresponding the zero candidates, the cost stays equal to the maximum value MAXVAL. Consequently, during the update candidates list process 2110, the zero candidates are at the end of the list.

To provide additional coding efficiency, a cost is computed for the candidates which the candidates use to fulfil the list of candidates (e.g. the zero candidates) and a separate, second reordering process is performed on them and they are set at the end of the list. This example improves the coding efficiency, particularly when the number of this kind of candidate is high.

In one example, when the list contains no more than one candidate except the candidates set to fulfill the list (e.g. the zero candidates) no reordering process is applied. This is illustrated in FIG. 21 in module (2114).

### Duplicate Candidates

In one example, the predictors which are duplicated in the list are not reordered during the reordering process. One implementation of this consists in changing the derivation of the candidates. For example, the zero candidates are added with a duplicate check (either when they all have been added or during the process of adding), a variable numNonDuplicateCand is set equal to the current number of candidates in the list. Then the zero candidates are added without duplicate check to fulfill the list. During the reordering process, all candidates with higher indexes will not be reordered and kept at the end of the list. All previous features can be applied, for example the cost computation, signalling and processing of the non-reordered candidates.

The advantage of this is coding efficiency improvement as when the zero candidates have a small cost, it will not use several consecutive indexes at the beginning of the list which is particularly inefficient. Such a scenario is surprisingly common and as such this change can have a significant impact on coding efficiency-particularly for short video sequences.

It is possible to dynamically change the reordering process in dependent on the coding mode. For example, the candidates use to fulfill the list are not reordered in the list for some modes except one mode where only the duplicate candidates are not reordered.

### Template Matching Cost Computation

The following examples solve some issues related to the templates availabilities to compute cost. These examples are mainly dedicated to the template matching method. The availability of a template means that the template is outside the reference frame or outside a delimited area. A delimited area can be defined to reduce the memory access of such method.

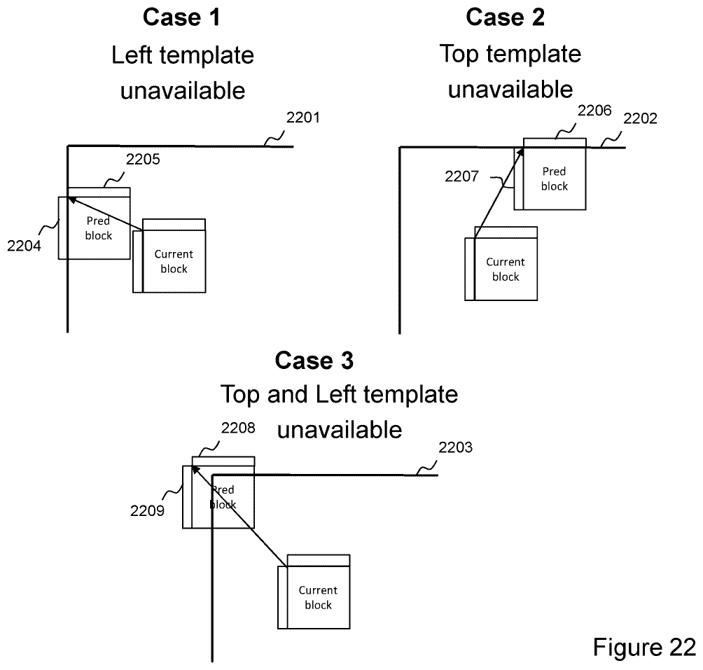

FIG. 22 illustrates 3 cases where templates for the predictor are not available. In this FIG. 2201 2202 2203 represents the border of the reference frame or of the delimited area. For the first case the left template (2204) is unavailable but the up template is available. For the second case the top template of predictor block is outside the reference frame or the restricted area (2202) and the left template is available (2207).

When a template is missing its related cost is by default set equal to 0. Consequently, these candidates have more chance to be selected compared to the others.

In the third case both templates (2208, 2209) are unavailable. The candidates related to these cases should have block predictors outside the reference frame and consequently they generally produce worse block predictors compared to blocks coming from the true reference frame. Indeed, when sample is outside the current frame the missing samples are replaced by the sample of the border line or column of the reference frame.

In order to ameliorate this problem of computing the cost of a template which is not present, when one template of the predictor block is not present, the cost which can't be computed is replaced by a value based on the cost value of a related available template. The advantage of this example is a coding efficiency improvement. Indeed, the cost will correspond to a value closest to the value that can be obtained when both templates are available. Compared to the existing method, a candidate in that case will not be set to an early position as its related cost has been computed with fewer samples than the other candidates.

Alternatively, the cost is computed as based on the size(s) of template(s), for example being proportional to the size of the template(s). The advantage is that the cost of the unavailable template will be statistically closest to the real cost and the comparison compared to the cost of the other candidates is fairer. This method may also be computationally simpler.

The proportionality could depend on the number of samples of the available template and on the non-available template. For example, for case 1 of FIG. 22, the cost, costLeft for the unavailable left template (CAO4) is set equal to the cost of up template (2205) costUP divided by the width and multiply by the height of the block as:

$$costLeft = ( costUp / width ) \times height .$$

So, the cost for the current candidates is:

$$cost = costUp + ( costUp / width ) \times height$$

FIG. 22 illustrates particular case 1 and case 2, but for some cases, only a part of the template is missing. In that case a partial cost can be computed on all available samples.

In such a casethe proportionality depends on the number of available samples and non-available samples. For example, if we consider the number of available samples numAvailableS, the number of non-available samples numNonAvailableS, the cost of available samples costAvailableS, the cost for the candidate can be:

cost=costAvailableS+(costAvailableS/numAvailableS)×numNonAvailableS

This can be applied to determine the cost for one template or for all templates.
The advantage compared to the previous embodiment is a better estimation of the real cost of the candidate.

For complexity reduction, the proportionality is a computed with shift operations. For example, a shift operation closest to the actual calculation can be used. For example, the denominator is approximated to the closest power of 2 value.

The advantage is a simplification, especially for hardware implementation as no division is used. (A shift operation is less complex than a division).

In an alternative example, the cost value for the non-available template is set equal to the cost value of the available template. For example, for the case 1 of FIG. 22, the cost is:

cost = costUp + costUp
Which is equivalent to
cost = costUp <<1
Where << is shift operation
Which is equivalent mathematically to
cost = costUp x 2

The advantage is a further simplification with minor impact on coding efficiency as many blocks are square blocks.

It has been noted that the cost may be underestimated for non-available templates. In order to ameliorate this a weight w may be applied on the formula to penalize the estimated cost for the candidate. In this case the basic formula for computing the cost is:

$$cost = costUp + w x ( costUp / width ) \times height$$

Where w is superior to one to penalize the estimated cost.

The advantage of this embodiment is a coding efficiency improvement, indeed, if there is a missing template the related block predictor in not likely to be very relevant. This weight will consequently produce a higher cost and will set, sometimes, the candidate in the lowest position in the final list.

In the above examples, we considered the top and left template with one line of samples as in the ECM. But longer templates, or more templates can be considered. As an example, the top right template, or the bottom left template may be considered.

In the same way further lines or row of templates can be considered to compute the cost. And also, the bi-prediction can be considered also for each of the above examples.

The third case of FIG. 22 illustrates the case where no template is available (2208 2209) for the current predictor. In that case, any cost can be computed.

In the case when no template is available for a predictor, the value is set equal to a maximum value. This ensures that the related candidates are not set at the begging of the list.

The advantage of this is a coding efficiency improvement as these candidates are not at the beginning of the list, compared to when the cost is set equal to 0. In practice, these candidates are not very efficient as they contain estimated samples and not true samples.

In a variation, the maximum value is inferior to a maximum value set for the candidate used to fulfill the list (e.g. the zero candidates). Indeed, these candidates are more efficient than such candidates which are added to fulfil the requirement to have a certain number of candidates.

In another variation, the candidates without available template are set at the end of the list and before the candidates which are added to fulfil the requirement to have a certain number of candidates (e.g. the zero candidates). Indeed, this can be achieved by setting their cost values equal to a maximum and highest maximum value for the zero candidates as described above.

In another example, when there is a missing template, the cost for the candidate is set equal to a maximum value in order that the candidate is at the end of the list. The advantage of this is a complexity reduction as no cost needs to be computed for the available template and also no adaptation of the cost. So, the coding efficiency is inferior compared to the previous embodiments with one template available but the complexity is inferior.

Advantageously the maximum value is inferior to the maximum value set for the candidate used to fulfill the list (e.g. the zero candidates). Indeed, these candidates are more efficient than such candidates.

When several candidates are in that case, these candidates keep the same ordering than in the initial list. For example, if candidate 1 is before a candidate 2 in the initial list in the reordered list candidate 1 is before candidate 2.

If only one template is missing for some candidate and more for other the candidates with only one missing candidate are set before the candidate which have all non-available templates.

### Restricting Reordering Based on the Availability of Templates

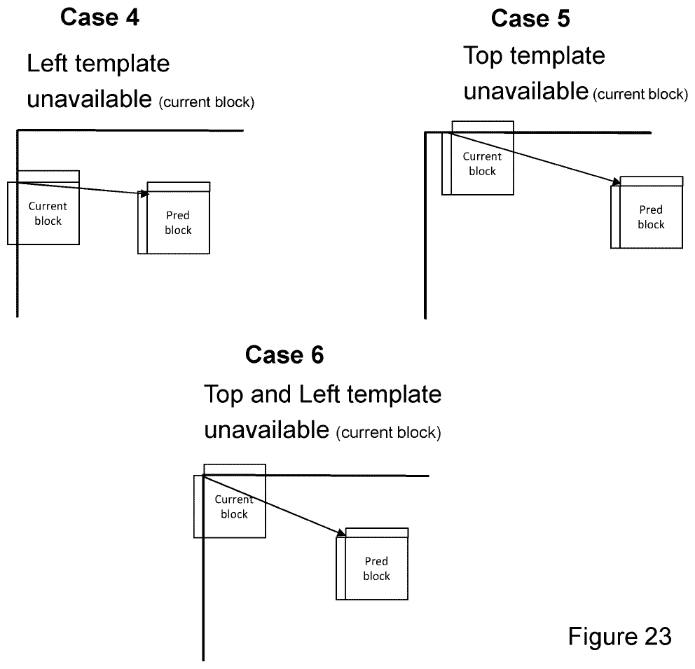

FIG. 23 illustrates three cases where the current block has no available templates (case 6) or the templates are partially available (case 4 and case 5). These cases are surprisingly prevalent when the bit rates is low, and for small sequences or for small slices.

In one example, when at least one template of the current block is not available, the list is not reordered. This may be achieved by not calculating a cost for any of the candidates.

The advantage is a small impact on coding efficiency with a complexity reduction.

To ameliorate the cases when at least one template is not available, the number of temporal candidates is increased. For example, in FIG. 19, the number of temporal of candidates is not 1 but a higher value. For example, this can be all temporal candidates. In the example of the current ECM implementation this can be 9 temporal candidates. Please note that in that case there is no AMRC for Temporal and non-adjacent candidates during the first ARMC processes

Additionally, so as to be able to derive diverse additional temporal candidates, the number of temporal positions used to derive temporal candidates can be increased.

Alternatively, the number of temporal candidates is the same as when the templates are available.

The advantage of this embodiment is a coding efficiency increase as when there is no available template (case 6) there is no spatial candidates, no history-based template and no non-adjacent candidates. And with only one temporal candidate no pairwise candidate can be derived. So, if more temporal candidates are added this increases the coding efficiency. This is particularly efficient at low bit rates and for small sequences or for small slices as cases 4, 5, 6 often happen.

In one alternative or additional example, the maximum number of candidates for those blocks is reduced. If only the temporal can be considered the maximum number of candidates should be 1 for example. In that case there is no cost related to the current block.

Additionally, when there is no temporal available because temporal candidate is forbidden or for the first Inter frame of a GOP, some modes can be avoided as all inter modes without motion vector residual as the Merge modes.

The advantage is a coding efficiency improvement for the related blocks.

In a further example, when there is no possible reordering, the motion vector threshold used is changed. As there are few possible spatial candidates, the motion vector threshold is reduced (if possible) in order to obtain more candidates in the list. This allows additional candidates to be added to the list without being deemed duplicates and potentially removed (and replaced with zero candidates).

This increases the coding efficiency as the list contains more candidates and fewer zero candidates which less useful.

### Bi-Directional Candidates

When a candidate is bi-directional, there are two possibilities to compute the cost related to templates. The first possibility is to compute the cost for each template independently for the first list and the second list and to sum these costs. If the uni-prediction is possible in the candidates set, the cost is divided by two.

The second possibility is to apply the bi-directional computation in order to obtain only one template for each top and the left templates, thanks to our example, and compute the cost of these bi-directional templates with the templates of the current block. This second possibility is particularly efficient when the Bi-prediction with CU-level weight (BCW) method is enabled.

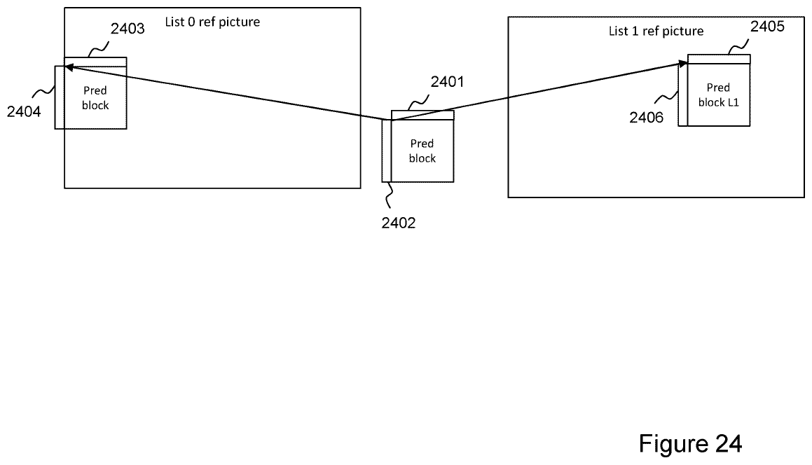

FIG. 24 illustrates a bi-directional prediction where the left template of the block predictor in L0 is unavailable.

In one embodiment, when the cost of each template is computed independently for bi-predicted candidates, and one template is not available for one direction and available for the second direction, the cost of available template is used to replace the cost of the non-available template. For example, in FIG. 24, if the cost costLeftL0 can't be computed, the final cost is set equal to:

$$cost = costLeft 1 ≪ 1 = costTopL 0 + costTopL 1$$

where costLeftL1 is the cost for the left template in L1 (2406), the costTopL0 is the cost for the top template in L0 and costTopL1 is the cost for the top template in L1. And << is the shift left operator. So costLeftL1<<1 means that cost costLeftL1 is multiplied by 2.

For reference, for cases where all templates are available the cost is computed by the following formula:

$$cost = costLeftL 0 + costLeftL 1 + costTopL 0 + costTopL 1$$

The advantage is a coding efficiency improvement.

In a related example, when one template is partially available, the cost is computed for the samples available and the cost for the non-available template corresponds to the cost of the related available template. The advantage is a computation of a cost closest to the real cost.

In a similar manner as described above, a penalty can be applied to the cost which replaces the current one or to the final cost.

It should be appreciated that more templates, lines or rows for the templates can be considered.

In a related, but alternative example, when a candidate is bi-directional and one template is not available for one direction and available for the second direction, the cost is computed on the available template without derivation of the bi-directional prediction. For example, in FIG. 24, if the left template of L0 is not available, only the uni-prediction of the left template is considered to compute the cost of the left template.

The advantage is a coding efficiency improvement.

In a similar manner to the above, when one template is partially available, the bi-prediction is computed for the samples available in both directions and the uni-prediction is considered for available samples in one direction when not available for the second direction. The advantage is a computation of a cost closest to the real cost.

In a similar manner as discussed above, a penalty may be applied to the cost which replaces the current one or to the final cost.

It is also possible to consider more templates, lines or rows for the templates.

All these embodiments can be combined unless explicitly stated otherwise. Indeed, many combinations are synergetic and may produce efficiency gains greater than a sum of their parts.

### Implementation of the Invention

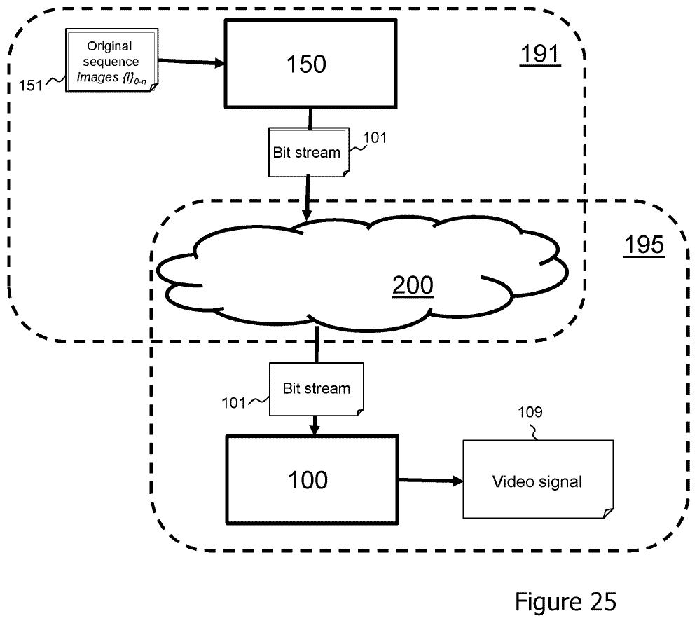

FIG. 25 shows a system 191 195 comprising at least one of an encoder 150 or a decoder 100 and a communication network 199 according to embodiments of the present invention. According to an embodiment, the system 195 is for processing and providing a content (for example, a video and audio content for displaying/outputting or streaming video/audio content) to a user, who has access to the decoder 100, for example through a user interface of a user terminal comprising the decoder 100 or a user terminal that is communicable with the decoder 100. Such a user terminal may be a computer, a mobile phone, a tablet or any other type of a device capable of providing/displaying the (provided/streamed) content to the user. The system 195 obtains/receives a bitstream 101 (in the form of a continuous stream or a signal—e.g. while earlier video/audio are being displayed/output) via the communication network 199. According to an embodiment, the system 191 is for processing a content and storing the processed content, for example a video and audio content processed for displaying/outputting/streaming at a later time. The system 191 obtains/receives a content comprising an original sequence of images 151, which is received and processed (including filtering with a deblocking filter according to the present invention) by the encoder 150, and the encoder 150 generates a bitstream 101 that is to be communicated to the decoder 100 via a communication network 191. The bitstream 101 is then communicated to the decoder 100 in a number of ways, for example it may be generated in advance by the encoder 150 and stored as data in a storage apparatus in the communication network 199 (e.g. on a server or a cloud storage) until a user requests the content (i.e. the bitstream data) from the storage apparatus, at which point the data is communicated/streamed to the decoder 100 from the storage apparatus. The system 191 may also comprise a content providing apparatus for providing/streaming, to the user (e.g. by communicating data for a user interface to be displayed on a user terminal), content information for the content stored in the storage apparatus (e.g. the title of the content and other meta/storage location data for identifying, selecting and requesting the content), and for receiving and processing a user request for a content so that the requested content can be delivered/streamed from the storage apparatus to the user terminal. Alternatively, the encoder 150 generates the bitstream 101 and communicates/streams it directly to the decoder 100 as and when the user requests the content. The decoder 100 then receives the bitstream 101 (or a signal) and performs filtering with a deblocking filter according to the invention to obtain/generate a video signal 109 and/or audio signal, which is then used by a user terminal to provide the requested content to the user.

Any step of the method/process according to the invention or functions described herein may be implemented in hardware, software, firmware, or any combination thereof. If implemented in software, the steps/functions may be stored on or transmitted over, as one or more instructions or code or program, or a computer-readable medium, and executed by one or more hardware-based processing unit such as a programmable computing machine, which may be a PC (“Personal Computer”), a DSP (“Digital Signal Processor”), a circuit, a circuitry, a processor and a memory, a general purpose microprocessor or a central processing unit, a microcontroller, an ASIC (“Application-Specific Integrated Circuit”), a field programmable logic arrays (FPGAs), or other equivalent integrated or discrete logic circuitry. Accordingly, the term “processor” as used herein may refer to any of the foregoing structure or any other structure suitable for implementation of the techniques describe herein.

Embodiments of the present invention can also be realized by wide variety of devices or apparatuses, including a wireless handset, an integrated circuit (IC) or a set of JCs (e.g. a chip set). Various components, modules, or units are described herein to illustrate functional aspects of devices/apparatuses configured to perform those embodiments, but do not necessarily require realization by different hardware units. Rather, various modules/units may be combined in a codec hardware unit or provided by a collection of interoperative hardware units, including one or more processors in conjunction with suitable software/firmware.

Embodiments of the present invention can be realized by a computer of a system or apparatus that reads out and executes computer executable instructions (e.g., one or more programs) recorded on a storage medium to perform the modules/units/functions of one or more of the above-described embodiments and/or that includes one or more processing unit or circuits for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more processing unit or circuits to perform the functions of one or more of the above-described embodiments. The computer may include a network of separate computers or separate processing units to read out and execute the computer executable instructions. The computer executable instructions may be provided to the computer, for example, from a computer-readable medium such as a communication medium via a network or a tangible storage medium. The communication medium may be a signal/bitstream/carrier wave. The tangible storage medium is a “non-transitory computer-readable storage medium” which may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. At least some of the steps/functions may also be implemented in hardware by a machine or a dedicated component, such as an FPGA (“Field-Programmable Gate Array”) or an ASIC (“Application-Specific Integrated Circuit”).

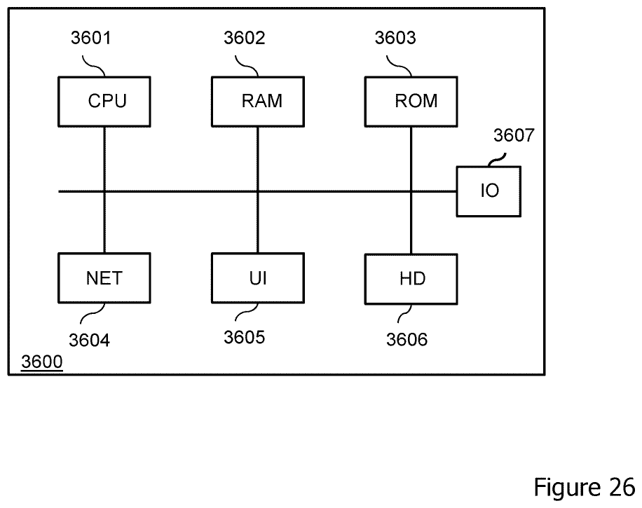

FIG. 26 is a schematic block diagram of a computing device 3600 for implementation of one or more embodiments of the invention. The computing device 3600 may be a device such as a micro-computer, a workstation or a light portable device. The computing device 3600 comprises a communication bus connected to: a central processing unit (CPU) 3601, such as a microprocessor; a random access memory (RAM) 3602 for storing the executable code of the method of embodiments of the invention as well as the registers adapted to record variables and parameters necessary for implementing the method for encoding or decoding at least part of an image according to embodiments of the invention, the memory capacity thereof can be expanded by an optional RAM connected to an expansion port for example; a read only memory (ROM) 3603 for storing computer programs for implementing embodiments of the invention; a network interface (NET) 3604 is typically connected to a communication network over which digital data to be processed are transmitted or received. The network interface (NET) 3604 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 3601; a user interface (UI) 3605 may be used for receiving inputs from a user or to display information to a user; a hard disk (HD) 3606 may be provided as a mass storage device; an Input/Output module (IO) 3607 may be used for receiving/sending data from/to external devices such as a video source or display. The executable code may be stored either in the ROM 3603, on the HD 3606 or on a removable digital medium such as, for example a disk. According to a variant, the executable code of the programs can be received by means of a communication network, via the NET 3604, in order to be stored in one of the storage means of the communication device 3600, such as the HD 3606, before being executed. The CPU 3601 is adapted to control and direct the execution of the instructions or portions of software code of the program or programs according to embodiments of the invention, which instructions are stored in one of the aforementioned storage means. After powering on, the CPU 3601 is capable of executing instructions from main RAM memory 3602 relating to a software application after those instructions have been loaded from the program ROM 3603 or the HD 3606, for example. Such a software application, when executed by the CPU 3601, causes the steps of the method according to the invention to be performed.

It is also understood that according to another embodiment of the present invention, a decoder according to an aforementioned embodiment is provided in a user terminal such as a computer, a mobile phone (a cellular phone), a table or any other type of a device (e.g. a display apparatus) capable of providing/displaying a content to a user. According to yet another embodiment, an encoder according to an aforementioned embodiment is provided in an image capturing apparatus which also comprises a camera, a video camera or a network camera (e.g. a closed-circuit television or video surveillance camera) which captures and provides the content for the encoder to encode. Two such examples are provided below with reference to FIGS. 37 and 38.

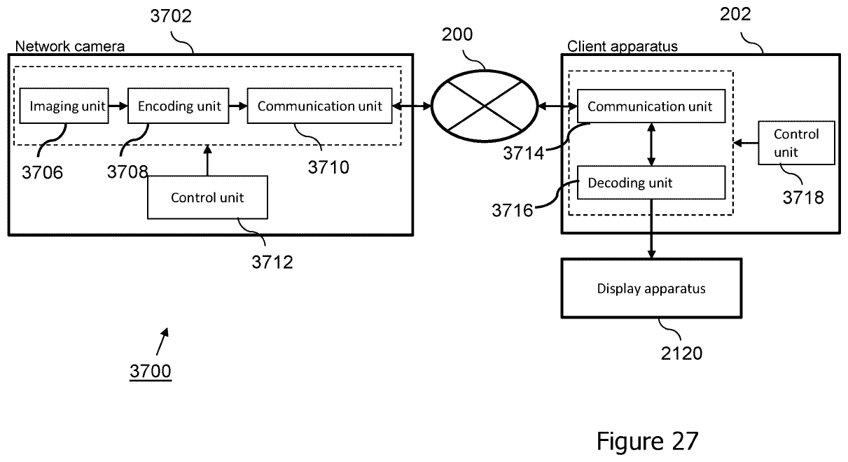

FIG. 27 is a diagram illustrating a network camera system 3700 including a network camera 3702 and a client apparatus 202.

The network camera 3702 includes an imaging unit 3706, an encoding unit 3708, a communication unit 3710, and a control unit 3712.

The network camera 3702 and the client apparatus 202 are mutually connected to be able to communicate with each other via the network 200.

The imaging unit 3706 includes a lens and an image sensor (e.g., a charge coupled device (CCD) or a complementary metal oxide semiconductor (CMOS)), and captures an image of an object and generates image data based on the image. This image can be a still image or a video image.

The encoding unit 3708 encodes the image data by using said encoding methods explained above, or a combination of encoding methods described above.

The communication unit 3710 of the network camera 3702 transmits the encoded image data encoded by the encoding unit 3708 to the client apparatus 202.

Further, the communication unit 3710 receives commands from client apparatus 202. The commands include commands to set parameters for the encoding of the encoding unit 3708.

The control unit 3712 controls other units in the network camera 3702 in accordance with the commands received by the communication unit 3712.

The client apparatus 202 includes a communication unit 3714, a decoding unit 3716, and a control unit 3718.

The communication unit 3714 of the client apparatus 202 transmits the commands to the network camera 3702.

Further, the communication unit 3714 of the client apparatus 202 receives the encoded image data from the network camera 3712.

The decoding unit 3716 decodes the encoded image data by using said decoding methods explained above, or a combination of the decoding methods explained above.

The control unit 3718 of the client apparatus 202 controls other units in the client apparatus 202 in accordance with the user operation or commands received by the communication unit 3714.

The control unit 3718 of the client apparatus 202 controls a display apparatus 2120 so as to display an image decoded by the decoding unit 3716.

The control unit 3718 of the client apparatus 202 also controls a display apparatus 2120 so as to display GUI (Graphical User Interface) to designate values of the parameters for the network camera 3702 includes the parameters for the encoding of the encoding unit 3708.

The control unit 3718 of the client apparatus 202 also controls other units in the client apparatus 202 in accordance with user operation input to the GUI displayed by the display apparatus 2120.

The control unit 3718 of the client apparatus 202 controls the communication unit 3714 of the client apparatus 202 so as to transmit the commands to the network camera 3702 which designate values of the parameters for the network camera 3702, in accordance with the user operation input to the GUI displayed by the display apparatus 2120.

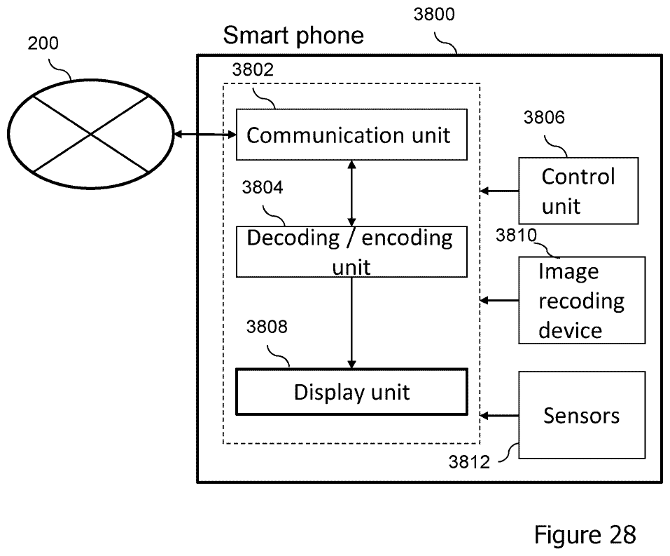

FIG. 28 is a diagram illustrating a smart phone 3800.

The smart phone 3800 includes a communication unit 3802, a decoding unit 3804, a control unit 3806 and a display unit 3808.

the communication unit 3802 receives the encoded image data via network 200.

The decoding unit 3804 decodes the encoded image data received by the communication unit 3802.

The decoding/encoding unit 3804 decodes/encodes the encoded image data by using said decoding methods explained above.

The control unit 3806 controls other units in the smart phone 3800 in accordance with a user operation or commands received by the communication unit 3806.

For example, the control unit 3806 controls a display unit 3808 so as to display an image decoded by the decoding unit 3804. The smart phone 3800 may also comprise sensors 3812 and an image recording device 3810. In such a way, the smart phone 3800 may record images, encode the images (using a method described above).

The smart phone 3800 may subsequently decode the encoded images (using a method described above) and display them via the display unit 3808—or transmit the encoded images to another device via the communication unit 3802 and network 200.

### Alternatives and Modifications

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It is also understood that any result of comparison, determination, assessment, selection, execution, performing, or consideration described above, for example a selection made during an encoding or filtering process, may be indicated in or determinable/inferable from data in a bitstream, for example a flag or data indicative of the result, so that the indicated or determined/inferred result can be used in the processing instead of actually performing the comparison, determination, assessment, selection, execution, performing, or consideration, for example during a decoding process.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Reference numerals appearing in the claims are by way of illustration only and shall have no limiting effect on the scope of the claims.

1. (canceled)

2. (canceled)

3. A method of decoding image data from a bitstream, the method comprising:
adding a first set of motion vector predictor candidates to said list;
determining duplicate candidates in said list;
adding a second set of motion vector predictor candidates to said list if the number of first set of motion vector predictor candidates is lower than a maximum candidate number so that the total number of candidates equals said maximum candidate number;
reordering said list of candidates;
wherein said duplicate candidates are excluded from said reordering.

4. The method of claim 3, wherein said second set of candidates are also excluded from said reordering.

5. The method of claim 3, wherein said second set of motion vector predictors are zero candidates and said first set of candidates are not zero candidates.

6. The method of claim 3, wherein said first set of candidates are candidates derived from at least one previously decoded or encoded motion information.

7. The method of claim 6, wherein said first set of candidates are candidates derived from true samples corresponding to one or more of temporal candidates, spatial candidates, historical candidates, previously used candidates, or candidates derived from other candidates

8. The method of claim 3, wherein said reordering is based on a computed relative cost of said candidates.

9. The method of claim 8, wherein said at least one candidate is derived from at least one spatially or temporally matched template;
wherein templates inside a delimited area are available and templates outside of the delimited area are non-available; and
if at least one template is non-available, computing a non-zero cost for said candidate.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The method of claim 3, comprising deriving a variable corresponding to the number of motion vector predictor candidates in the first set and the reordering of the list is performed in dependence on the variable.

44. The method of claim 43, wherein said variable identifies the first candidate from the second set of motion vector predictor candidates.

45. (canceled)

46. The method of claim 3, comprising setting the non-reordered motion vector predictor candidates to the end of the list.

47. The method of claim 46, comprising performing a second reordering process on the non-reordered motion vector predictor candidates.

48. The method of claim 46, comprising performing a second reordering process on the non-reordered motion vector predictor candidates when the first set contains no more than one candidate.

49. The method of claim 46, comprising performing a second reordering process on the non-reordered motion vector predictor candidates in dependence on the coding mode.

50. The method of claim 49, wherein said second reordering is not applied for subblock merge mode.

51. The method of claim 46, comprising performing a second reordering process on the non-reordered motion vector predictor candidates when the mode has a number of candidates above a threshold.

52. (canceled)

53. (canceled)

54. An encoding apparatus for encoding image data into a bitstream, the encoding apparatus comprising:
a generator which generates a list of motion vector predictor candidates for predicting motion in an image portion;
an adder which adds a first set of motion vector predictor candidates to said list and a second set of motion vector predictor candidates to said list, wherein the second set of motion vector predictors are added to said list if the number of first set of motion vector predictor candidates is lower than a maximum candidate number so that the total number of candidates equals said maximum candidate number;
a determiner which determines duplicate candidates in said list;
a reordering unit which reorders said list of candidates, wherein said duplicate candidates are excluded from said reordering.

55. A decoding apparatus for decoding image data from a bitstream, the decoding apparatus comprising:
a generator which generates a list of motion vector predictor candidates for predicting motion in an image portion;
an adder which adds a first set of motion vector predictor candidates to said list and a second set of motion vector predictor candidates to said list, wherein the second set of motion vector predictors are added to said list if the number of first set of motion vector predictor candidates is lower than a maximum candidate number so that the total number of candidates equals said maximum candidate number;
a determiner which determines duplicate candidates in said list;
a reordering unit which reorders said list of candidates, wherein said duplicate candidates are excluded from said reordering.

56. A non-transitory computer readable storage medium carrying a computer program comprising instructions adapted to perform, when executed in a computing device, a method of decoding image data from a bitstream, the method comprising:
generating a list of motion vector predictor candidates for predicting motion in an image portion;
adding a first set of motion vector predictor candidates to said list;
determining duplicate candidates in said list;
adding a second set of motion vector predictor candidates to said list if the number of first set of motion vector predictor candidates is lower than a maximum candidate number so that the total number of candidates equals said maximum candidate number;
reordering said list of candidates;
wherein said duplicate candidates are excluded from said reordering.

57. (canceled)

58. A non-transitory computer readable storage medium carrying a computer program comprising program instructions adapted to perform, when executed in a computing device, a method of encoding image data into a bitstream, the method comprising:
generating a list of motion vector predictor candidates for predicting motion in an image portion;
adding a first set of motion vector predictor candidates to said list;
determining duplicate candidates in said list;
adding a second set of motion vector predictor candidates to said list if the number of first set of motion vector predictor candidates is lower than a maximum candidate number so that the total number of candidates equals said maximum candidate number;
reordering said list of candidates;
wherein said duplicate candidates are excluded from said reordering.

59. A method of encoding image data into a bitstream, the method comprising:
generating a list of motion vector predictor candidates for predicting motion in an image portion;
adding a first set of motion vector predictor candidates to said list;
determining duplicate candidates in said list;
adding a second set of motion vector predictor candidates to said list if the number of first set of motion vector predictor candidates is lower than a maximum candidate number so that the total number of candidates equals said maximum candidate number;
reordering said list of candidates;
wherein said duplicate candidates are excluded from said reordering.
